(19) United States
(12) Patent Application Publication
(10) Pub. No.: US 2006/0271437 A1
(43) Pub. Date: Nov. 30, 2006

(54) System and method for home product delivery

(76) Inventor: Frank S. Maggio, St. Petersburg, FL (US)

Correspondence Address: KING & SPALDING LLP, 1180 PEACHTREE STREET, ATLANTA, GA, 30309, US

(21) Appl. No.: 11/439,632

(22) Filed: May 24, 2006

Related U.S. Application Data
(60) Provisional application No. 60/685,080, filed on May 26, 2005.

(51) Int. Cl. G07G 1/14

(52) U.S. Cl. 705/14

(57) ABSTRACT

Methods and systems for receiving orders for products, such as groceries, from a consumer and delivering the ordered products to the consumer's homes include receiving orders generated by scanning a product's bar code. Based on the bar code information, information for the used product, competing products, and complimentary products can be presented to the Consumer. The consumer selects a product, and the selection is communicated to the product deliverer for scheduled home delivery to the consumer. The consumer can scan the bar code, receive product options, and transmit orders to the home grocery delivery provider by utilizing a hand-held device to communicate data corresponding with a desired product to a server computer, which can communicate with a store that will deliver the product to the consumer. The grocery provider can stock common home delivery items in a separate store section to allow quick in-store shopping of those common items.

### RELATED PATENT APPLICATION

This patent application claims priority under 35 U.S.C. § 119 to U.S. Provisional Patent Application No. 60/685,080, entitled “Viable Method and System for Providing Goods to Consumers,” filed May 26, 2005. The complete disclosure of the above-identified priority application is hereby fully incorporated herein by reference.

### TECHNICAL FIELD

The invention relates to systems and methods for delivering groceries and other products to consumers. In particular, the invention relates to systems and methods for generating product orders and delivering the products from local, regional, or national locations.

### BACKGROUND

The members of nearly every household in America spend a significant amount of time shopping for groceries. Under the traditional model, consumers travel to grocery stores to purchase products such as food, beverages, and various other sundries for consumption at home. The entire process of determining what products to buy, traveling to the store, searching through the store for the products to buy, purchasing the products from the store, loading the consumer's vehicle with the purchased products, traveling back home, and unloading all of the products can be extremely time consuming.

Many consumers have considerable time constraints due to busy schedules. Such consumers often cannot dedicate the necessary time to engage in the entire process of grocery shopping on a regular basis. These consumers likewise may not be able to dedicate the time to plan an efficient shopping trip by keeping a list of needed or desired products, and scheduling a trip to the store before depleting the household's stock of necessary or staple products.

Several innovations have been developed to address the need to make the shopping experience more efficient. One of the more recent of these innovations is the delivery of groceries directly to consumers' homes. Several models of delivering groceries to consumers' homes have been developed, but the basic principle in each model is that consumers select what products they want and communicate those selections to a store, and the store then delivers those products to the consumer.

Models of delivering groceries to consumers' homes currently known have had drawbacks that prevented them from significantly increasing the efficiency of the shopping process. These drawbacks include the cost of delivering the groceries to consumers and the corresponding inability for the grocers to compete with existing, traditional stores. Other drawbacks relate to efficient preparation of a shopping list, communications between consumers and the grocery delivery business, and the logistics of delivering the groceries, including the need for the consumer to be home at a specified time to receive the groceries and possible spoilage of perishable groceries while en route from the store to the consumer or when delivered when the consumer is not at home to take the groceries indoors.

Therefore, a need in the art exists for a method and system for delivering groceries and other products to consumers' homes that address the drawbacks of the existing models of delivering groceries. Specifically, a need in the art exists for a cost-effective way to retrieve orders from consumers and deliver the ordered products to the consumers. A further need exists for a way to deliver the ordered products—both perishable and non-perishable—to the consumers without requiring a consumer to be at home during the time of delivery.

### SUMMARY

The invention can provide methods and systems for retrieving orders for products, such as groceries, from consumers and delivering the ordered products to the consumers' homes.

In one aspect, a consumer can utilize a device to indicate to a server a desire to purchase a given product. The consumer can indicate the desired product to the server by utilizing the device to scan a bar code corresponding with the product and to transmit a signal corresponding with the bar code to the server. The consumer also can indicate the desired product to the server by utilizing the device to search for the desired product and to send a signal corresponding with that desired product to the server. Regardless of how the consumer indicates the desired product to the server, the server can communicate with a store that sells the desired product, instructing the store to deliver the desired product to the consumer.

The device utilized by the consumer to indicate the desired product can be a hand-held device that can scan a machine-readable mark from a writing, such as a product's bar code, to obtain information regarding the product desired by the consumer. Alternatively, the hand-held device can read a radio frequency identification (“RFID”) tag on the product to obtain the information regarding the product desired by the consumer. The hand-held device can transmit and receive signals via a network such as the internet. The hand-held device can comprise a screen that displays visual content to the consumer. The hand-held device can be ergonomically designed, and can function and appear as a remote control.

In another aspect, the products ordered by a consumer can be delivered to the consumer. The delivery process can include scheduling a delivery time. Deliveries can be scheduled when certain products are needed, or rules can be set by the consumer to deliver ordered products periodically.

When the desired products are delivered to the consumer, they can be placed in a storage device that can be opened only by a limited set of people who have been granted access by the consumer. The consumer can provide access to the limited set of people by providing them with a physical key or an electronic access code. The consumer also can utilize a biometric reading device to authorize the limited set of people to access the storage device. The storage device can include a refrigerated storage device and a power supply, and can transmit and receive signals via a network such as the internet.

In yet another aspect, data associated with consumers can be stored. The associated data can include the consumer's demographic information, past order history, and television viewing data. The stored data then can be transmitted to companies interested in the data. These companies can utilize the data to send promotions to specific consumers and measure the efficacy of advertisements presented by the companies.

In still another aspect, a store can have a specialized portion that comprises one or more of a number of products, and a main portion that comprises one or more of those products, in addition to one or more of a number of other products. The products in the specialized portion can be those products that are among the most commonly purchased types of products from grocery stores and that are available for home ordering and delivery.

Those and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for delivering products to consumers according to an exemplary embodiment.

FIG. 2 is a block diagram depicting a system for delivering products to consumers according to an alternative exemplary embodiment.

FIG. 3 is a block diagram depicting the home components of a system for delivering products to consumers according to another exemplary embodiment.

FIG. 4 is a block diagram depicting a system for delivering products to consumers according to another exemplary embodiment.

FIG. 5 is a block diagram depicting the components of an interactive remote control according to an exemplary embodiment.

FIG. 6 is a plan diagram depicting the form factor of an interactive remote control according to an exemplary embodiment.

FIG. 7 is a block diagram depicting the components of a smart pantry according to an exemplary embodiment.

FIG. 8 is a flow chart depicting a method for delivering products to consumers according to an exemplary embodiment.

FIG. 9 is a flow chart depicting a method for receiving an order from a consumer according to an exemplary embodiment.

FIG. 10 is a flow chart depicting a method for processing and delivering a consumer order according to an exemplary embodiment.

FIG. 11 is a flow chart depicting a method for receiving a consumer order based on a bar code scan according to an exemplary embodiment.

FIG. 12 is a flow chart depicting a method for receiving a consumer order based on a product search according to an exemplary embodiment.

FIG. 13 is a flow chart depicting a method for receiving an order based on a response to a promotion according to an exemplary embodiment.

FIG. 14 is a flow chart depicting a method for receiving an order based on a product shown on television according to an exemplary embodiment.

FIG. 15 is a flow chart depicting a method for delivering a received order to a consumer according to an exemplary embodiment.

FIG. 16 is a flow chart depicting a method for registering a consumer according to an exemplary embodiment.

FIG. 17 is a flow chart depicting a method for delivering ordered products from a consumer's local store according to an exemplary embodiment.

FIG. 18 is a flow chart depicting a method for delivering ordered products from a hub store according to an exemplary embodiment.

FIG. 19 is a flow chart depicting a method for delivering ordered products from a local store other than the consumer's local store according to an exemplary embodiment.

FIG. 20 is a flow chart depicting a method for delivering ordered products from an affiliated store according to an exemplary embodiment.

FIG. 21 is a flow chart depicting a method for scheduling delivery of aggregated ordered products according to an exemplary embodiment.

FIG. 22 is a flow chart depicting a method for accessing a smart pantry according to an exemplary embodiment.

FIG. 23 is a flow chart depicting a method for stocking a store to allow quick-shopping of common products available for home order and delivery according to an exemplary embodiment.

FIG. 24 is a flow chart depicting a method for providing a consumer with a scavenger hunt promotion for a product according to an exemplary embodiment.

### DETAILED DESCRIPTION OF THE EXEMPLARY EMBODIMENTS

The exemplary systems and methods described herein enable home product delivery providers to receive orders for groceries and other products from consumers and to deliver the ordered products to the consumers' homes. The consumers can transmit orders to the home grocery delivery provider by utilizing a hand-held device to communicate data corresponding with a desired product to a server computer, which then can communicate with a store that can deliver the product to the consumer.

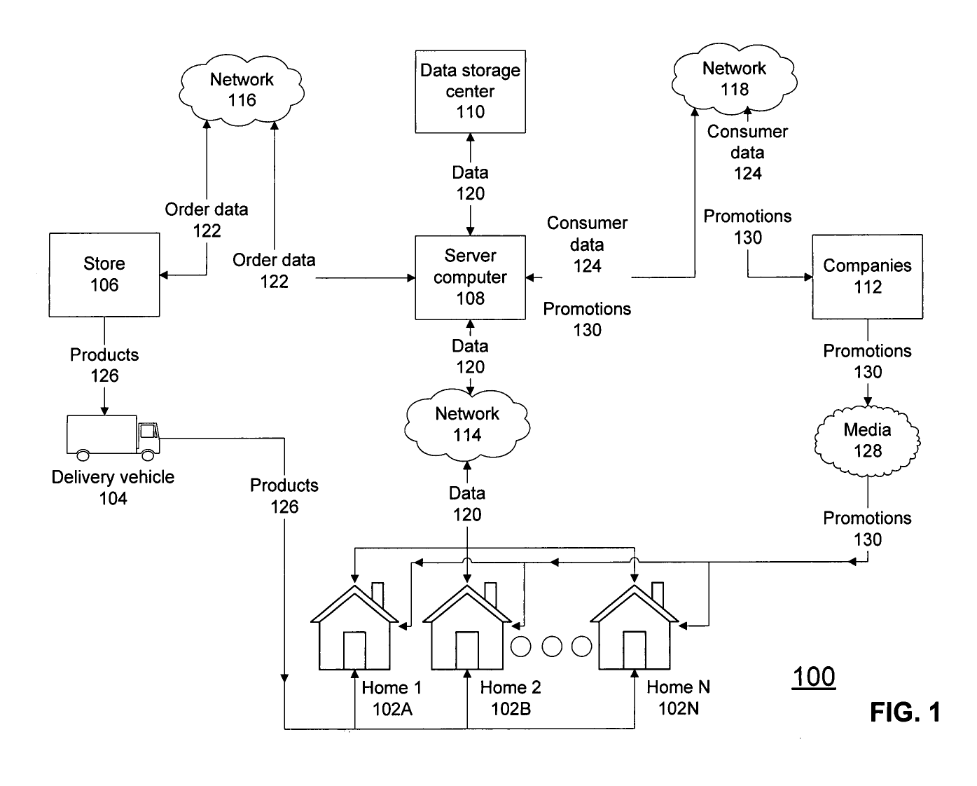

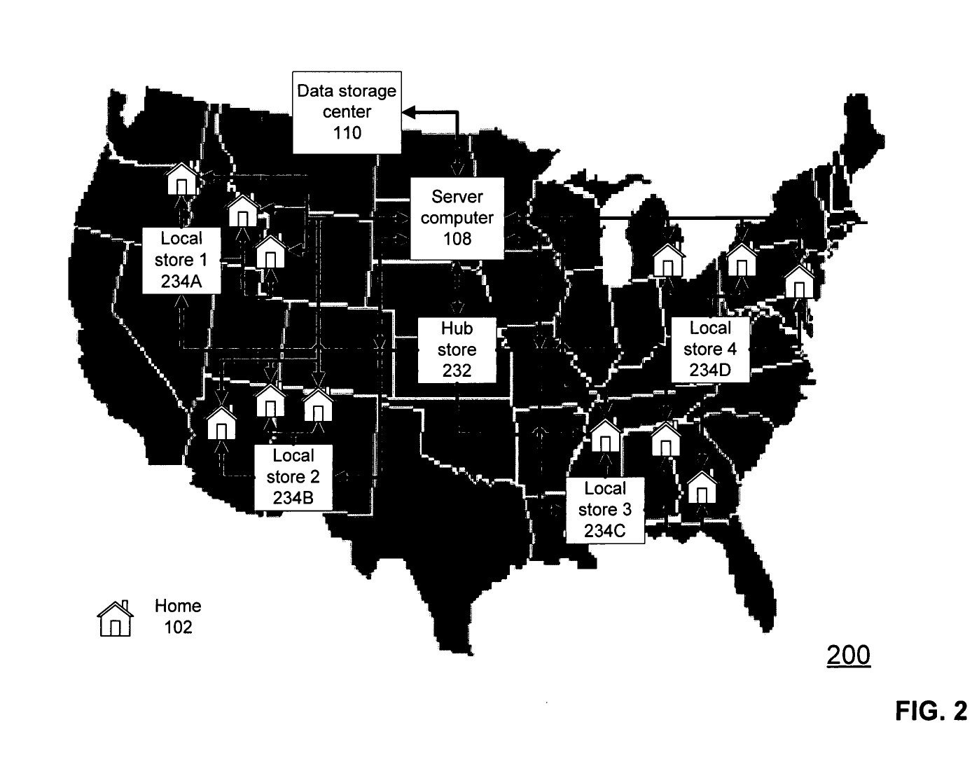

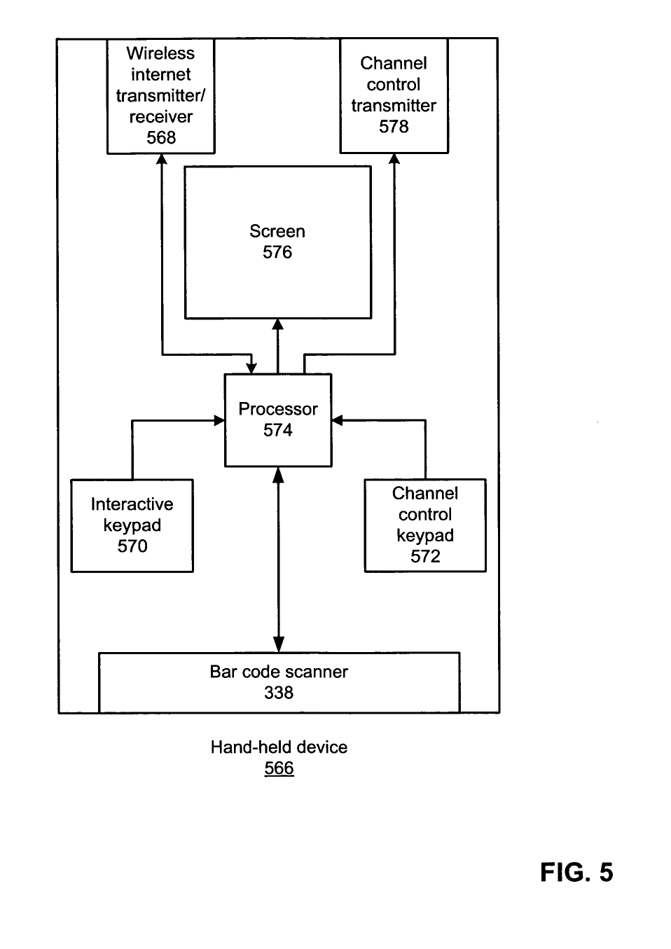

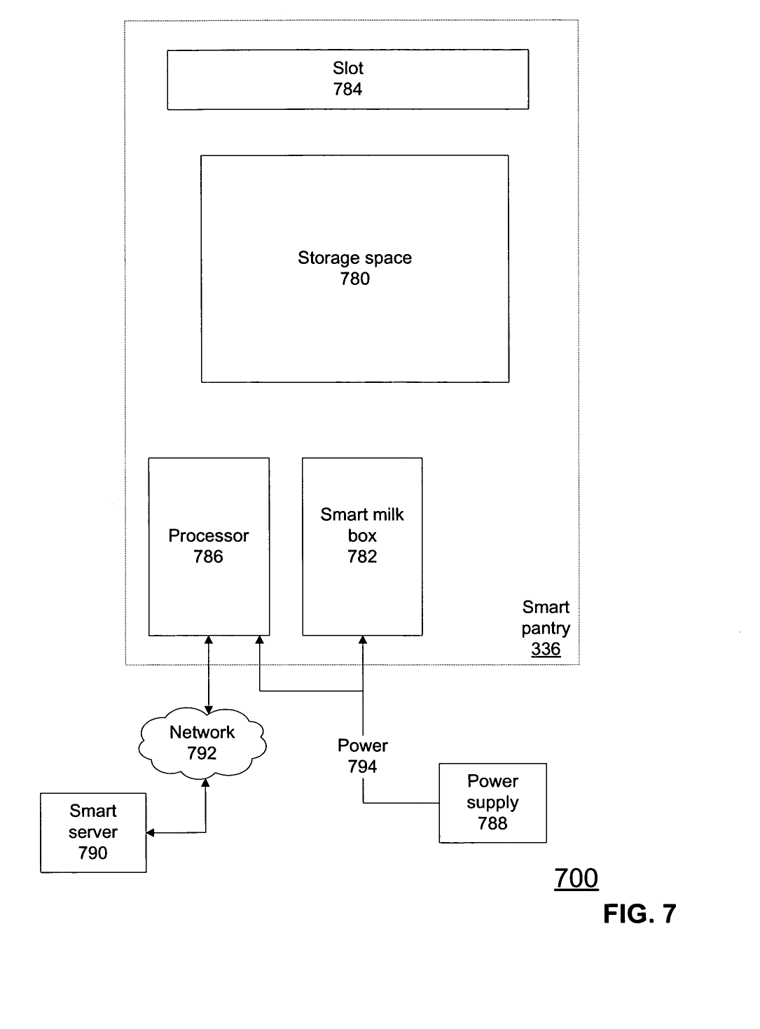

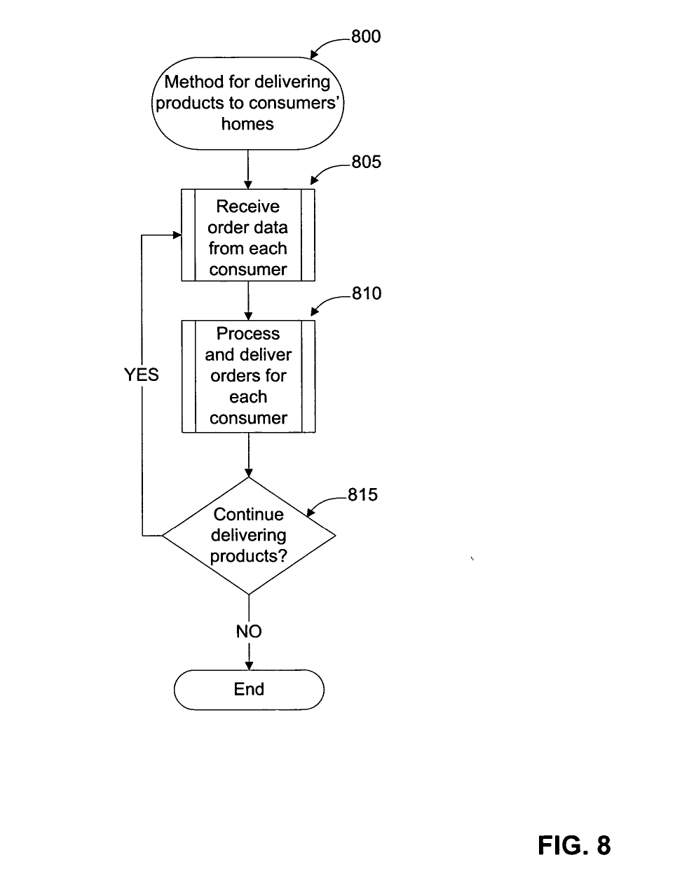

A method and system for home grocery delivery will now be described with reference to FIGS. 1-24, which depict representative or illustrative embodiments. FIGS. 1-7 are diagrams depicting components of systems for delivering products to consumers' homes according to exemplary embodiments. The elements depicted in FIGS. 1-7 will be discussed in more detail with reference to the methods illustrated in FIGS. 8-24.

FIG. 8 is a flow chart depicting a method 800 for delivering products 126 to consumers' 302 homes 102 according to an exemplary embodiment. The method 800 will be described with reference to FIGS. 1-8.

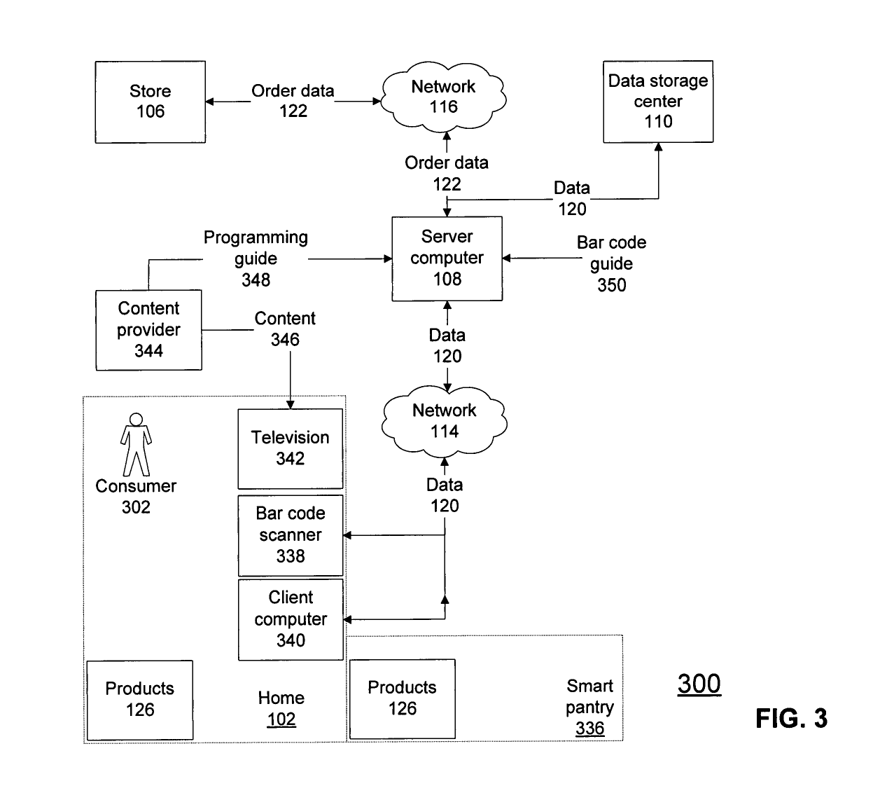

In step 805, orders from each consumer 302 are received. In exemplary embodiments, the orders can be transmitted as data 120 comprising order data 122 from a consumer's 302 home 102 to a server computer 108 via a network 114. As shown in FIG. 3, homes 102 can comprise a consumer 302, a television 342 that can receive content 346 (for example, television entertainment and advertisement content) from a content provider 344 (for example, a broadcaster or cable/satellite provider), a bar code scanner 338, a client computer 340, and products 126, even though these components are not shown in FIG. 1. In exemplary embodiments, the order data 122 received from each consumer 302 can comprise data 120 representing orders for products 126. In certain embodiments, the order data 122 can be transmitted from a hand-held device 566 utilized by the consumer 302. In exemplary embodiments, the hand-held device 566 comprises a bar code scanner 338, a display screen 576, and a wireless internet transmitter/receiver 568 for communicating data 120 with a server 108 over a network 114 such as the internet.

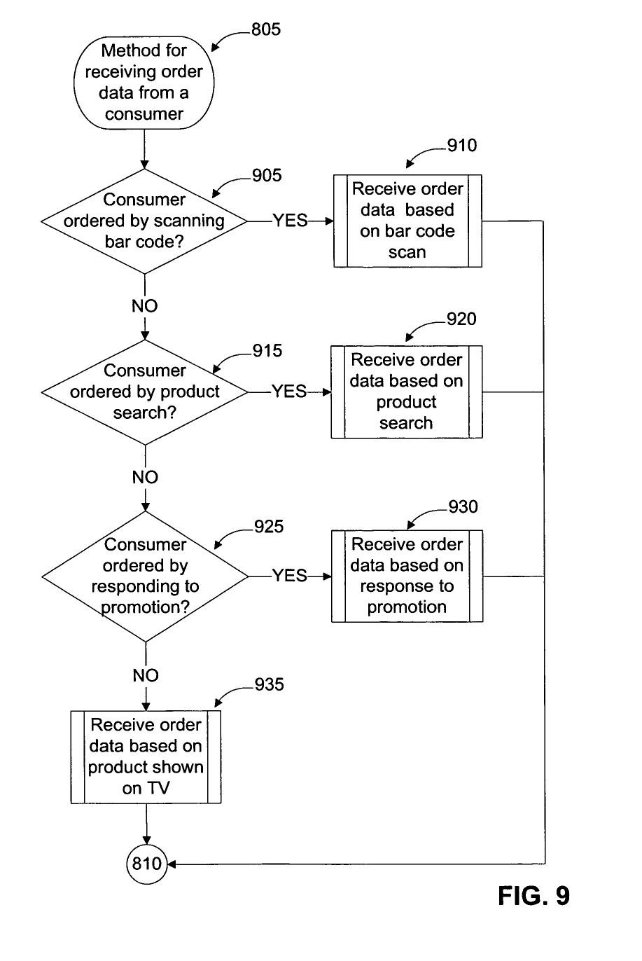

Consumers 302 can transmit order data 122 via the hand-held device 566 by various methods. In exemplary embodiments, these methods, which will be discussed in more detail with reference to FIGS. 9 and 11-14, can include scanning a writing such as a bar code associated with a desired product 126, searching for a desired product 126, responding to a promotional offer 130 for a desired product 126, and indicating a desire to purchase a product 126 shown on television 342.

Step 805 will be discussed in more detail with reference to FIG. 9.

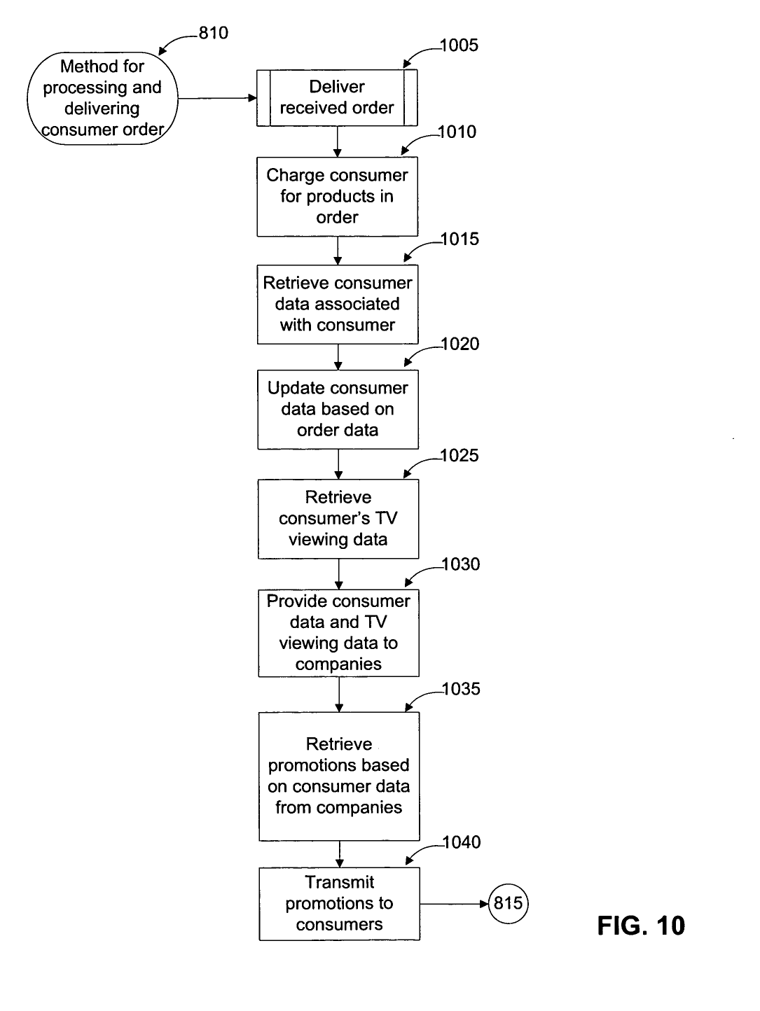

In step 810, the order data 122 received from each consumer 302 in step 805 is processed and then products 126 corresponding with the order data 122 are delivered to the consumers. In exemplary embodiments, each consumer's 302 order data 122 can be processed by the server computer 108. Each consumer's 302 ordered products 126 also can be delivered to the consumer's 302 home 102. Step 810 will be discussed in more detail with reference to FIG. 10.

In step 815, the method 800 determines whether to continue delivering products 126 to consumers 302. If the delivery is to continue, the method 800 returns to step 805. Otherwise, the method 800 ends.

FIG. 9 is a flow chart depicting a method 805 for receiving order data 122 from a consumer 302 according to an exemplary embodiment, as referenced in step 805 of FIG. 8. The method 805 will be described with reference to FIGS. 1-7 and 9. As discussed, the method 805 can be performed for each of multiple consumers 302.

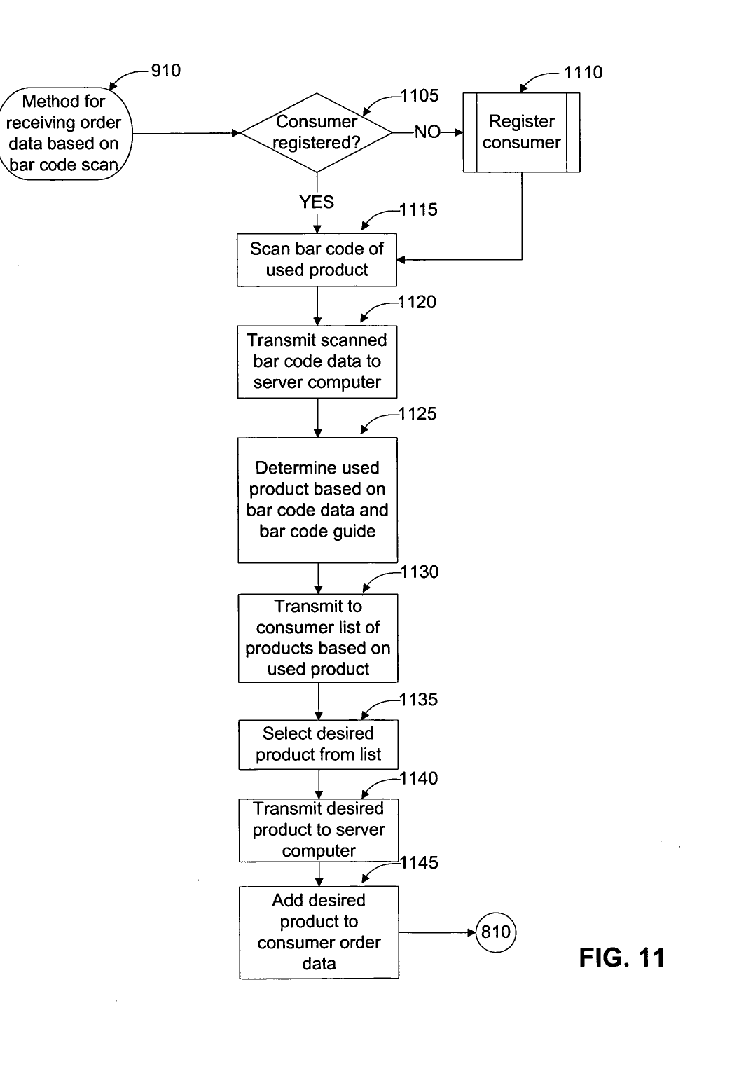

In step 905, the method 805 determines whether the consumer 302 ordered by scanning a bar code. If the consumer 302 ordered by scanning a bar code, the method 805 branches to step 910. In step 910, the order data 122 based on a bar code scan is received by the server computer 108. After step 910, which will be discussed in more detail with reference to FIG. 11, the method 805 then proceeds to step 810.

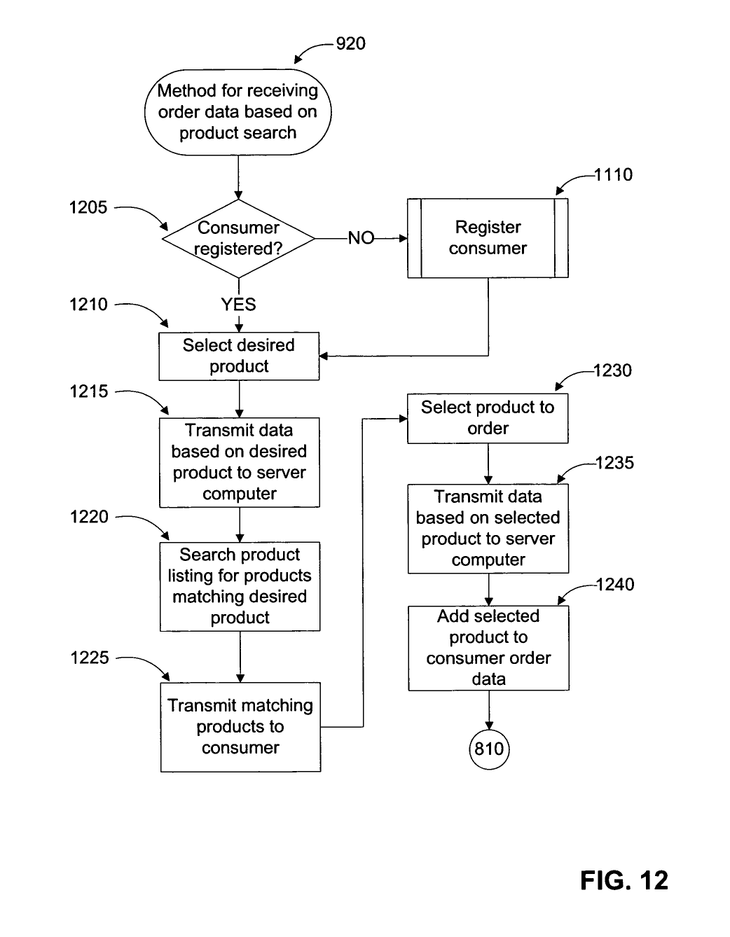

If the consumer 302 did not order by scanning a bar code, the method 805 branches to step 915. In step 915, the method 805 determines whether the consumer 302 ordered by searching for the desired product 126 via a database of stored products. If the consumer 302 ordered by searching for the desired product 126, the method 805 branches to step 920. In step 920, the order data 122 based on a product search is received by the server computer 108. After step 920, which will be discussed in more detail with reference to FIG. 12, the method 805 then proceeds to step 810.

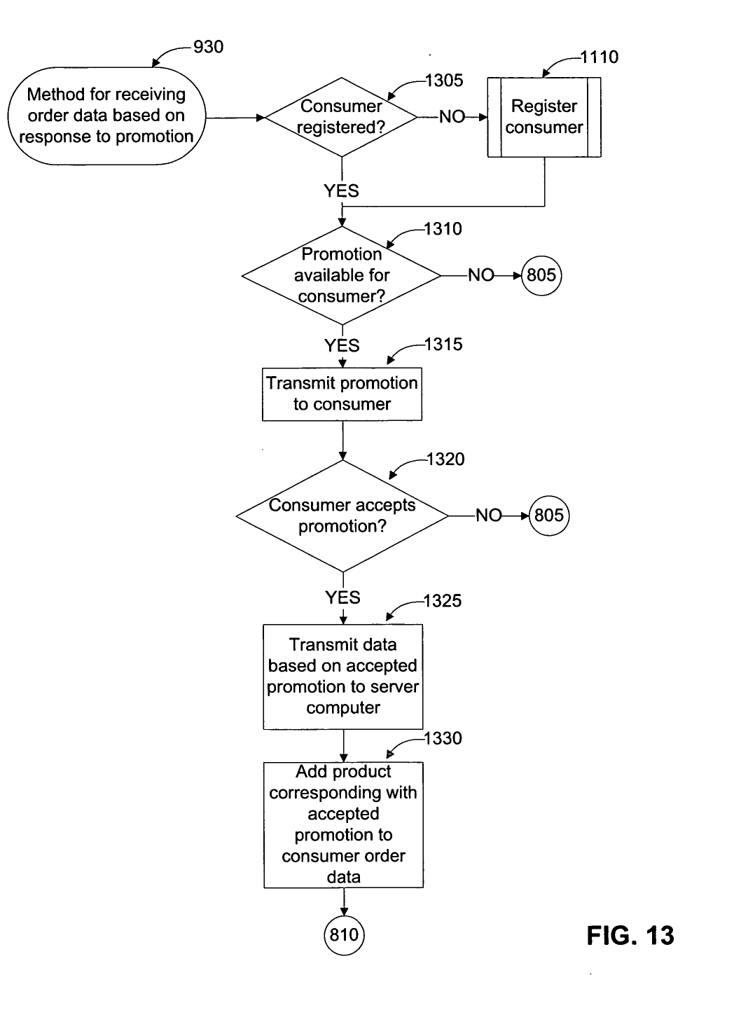

If the consumer 302 did not order by searching for the desired product 126, the method 805 branches to step 925. In step 925, the method 805 determines whether the consumer 302 ordered by responding to a promotion 130. If the consumer 302 ordered by responding to a promotion 130, the method 805 branches to step 930. In step 930, the order data 122 based on a response to a promotion 130 is received by the server computer 108. After step 930, which will be discussed in more detail with reference to FIG. 13, the method 805 then proceeds to step 810.

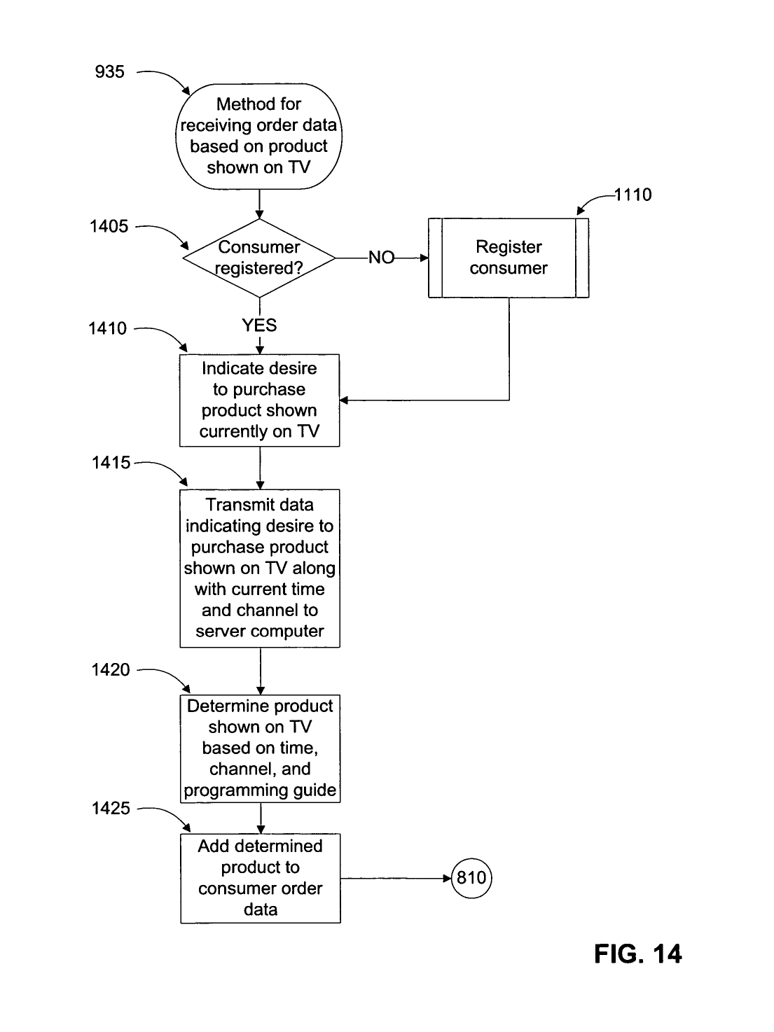

If the consumer 302 did not order by responding to a promotion 130, the method 805 proceeds to step 935. In step 935, the order data 122 based on a product 126 shown on television 342 is received by the server computer 108. After step 935, which will be discussed in more detail with reference to FIG. 14, the method 805 then proceeds to step 810.

FIG. 11 is a flow chart depicting a method 910 for receiving order data 122 based upon a bar code scan according to an exemplary embodiment, as referenced in step 910 of FIG. 9. The method 910 will be described with reference to FIGS. 1-7 and 11.

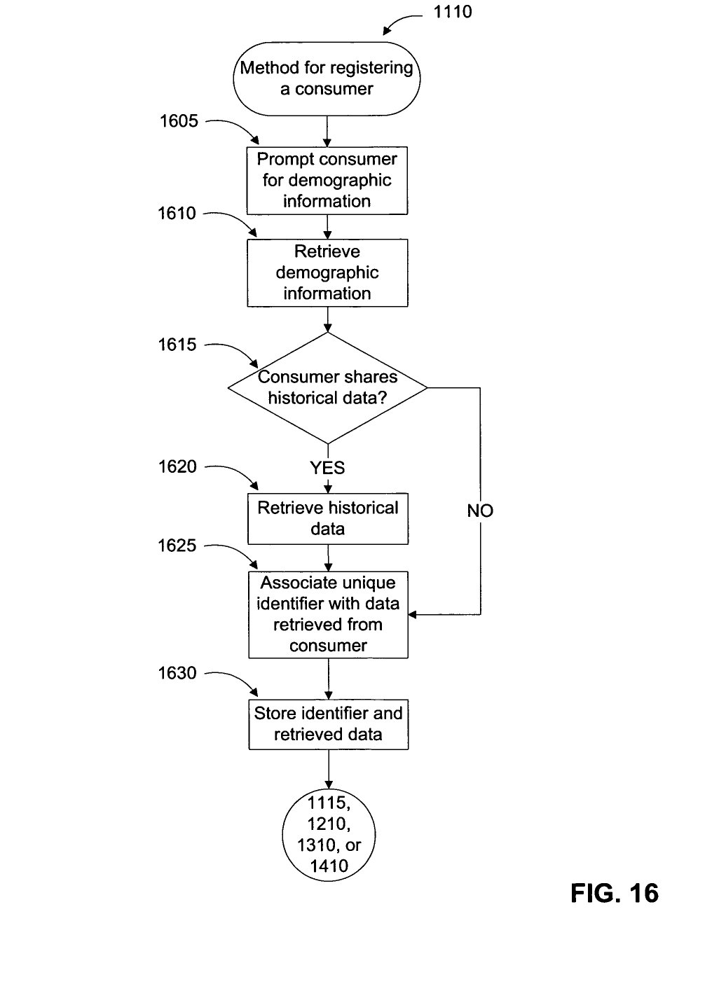

In step 1105, the method 910 determines if the consumer 302 corresponding with the order data 122 is registered. In exemplary embodiments, determining if a given consumer 302 is registered can comprise searching a data storage center 110 for consumer data 124 corresponding with the given consumer 302. If the consumer 302 is not registered, the method 910 branches to step 1110, where the consumer 302 is registered. After step 1110, which will be discussed in more detail with reference to FIG. 16, the method 910 proceeds to step 1115. Step 1115 is also reached directly if the method 910 determined in step 1105 that the consumer 302 was registered.

In step 1115, the consumer 302 scans the bar code of a used product 126. As used herein, the term “bar code” refers to a series of machine-readable marks of varying type, in which digits or characters of an alphabet are represented by a different pattern within the series. One type of bar code comprises a series of vertical bars of varying width, in which each of the digits zero through nine are represented by a different pattern of bar that can be read by a laser scanner. Examples of bar codes include universal product codes (“UPCs”) that are printed on the packaging of most products 126 commercially sold in the United States.

In certain embodiments, the used product 126 can be any product 126 that the consumer 302 has used or consumed. After consumption of the product 126, the consumer 302, as discussed above, can utilize a hand-held device 566 comprising a bar code scanner 338, a display screen 576, and a wireless internet transmitter/receiver 568 for communicating data 120 with a server 108 over a network 114 to scan the bar code of the used product 126. In exemplary embodiments, the bar code scanner 338 need not be part of a hand-held device 566. For example, the bar code scanner 338 can be located near, or attached to, a trash receptacle in the consumer's 302 home 102. In such embodiments, the consumer 302 can scan the bar code of a used product 126 when disposing of the empty product 126 packaging.

In exemplary embodiments, consumers 302 ordering products 126 from a store 106 by scanning the bar code of used products 126 can purchase initially at least two of each product 126 regularly purchased by the consumer 302. In such embodiments, the consumer 302 can scan the bar code when the first unit of a given product 126 is consumed, thereby placing an order for a new one, which can be delivered to the consumer 302 before the consumer 302 consumes the second product 126 unit.

In other embodiments, the consumer 302 can scan the bar code of any product 126 in the consumer's 302 home 102, regardless of whether the product 126 has been consumed. In still other embodiments, the consumer 302 can scan a bar code corresponding with a product 126 the consumer 302 wishes to order, regardless of whether the consumer 302 has purchased the product 126. For example, a consumer 302 can scan the bar code corresponding with a product 126 that appears in a newspaper or magazine advertisement, or a consumer 302 can scan the bar code from the packaging of a product 126 belonging to another person.

In certain embodiments, the hand-held device 566 can comprise a scanner that can acquire data 120 from items without a bar code. For example, the hand-held device 566 can comprise an RFID device that can acquire data 120 from items that have an associated RFID tag. The RFID device can be an RFID scanner or reader that supplies radiant energy to an RFID tag, coupled to a product 126, an advertisement, or to another physical item, and collects or receives energy that passively scatters back or otherwise emanates from the tag in response to the radiant energy. Alternatively, the hand-held device 566 can comprise an RFID scanner that receives RF signals actively emanating from a RFID tag via a radio frequency (“RF”) source or generator connected to the tag. Thus, an RFID device associated with the hand-held device 566 can scan passive RFID tags that lack an onboard power supply or active RFID tags that have an onboard power supply. Throughout this application, any embodiment comprising a bar code scanner or use thereof also can comprise an RFID tag scanner or use thereof.

In step 1120, data 120 corresponding with the bar code (or RFID tag) scanned in step 1115 is transmitted to the server computer 108. In exemplary embodiments, the hand-held device 566 utilized to scan the bar code also can comprise a processor 574 that can generate the data 120 that corresponds with the scanned bar code. The hand-held device 566 then can utilize a wireless internet transmitter/receiver 568 to transmit the data 120 to a server computer 108 via a network 114 such as the internet.

The wireless internet transmitter/receiver 568 utilized by the hand-held device 566 can comprise a WiFi or WiMax transmitter/receiver 568. In such embodiments, the device 566 can transmit and receive data 120 via a WiFi or WiMax internet signal when the hand-held device 566 is within the range of an active WiFi or WiMax internet signal. In alternative embodiments, the wireless internet transmitter/receiver 568 can comprise any transmitter/receiver 568 that can communicate with the server computer 108 via the internet when the hand-held device 566 is not necessarily in range of an active WiFi or WiMax internet signal. Examples of types of such wireless communications are known to those in the art, and can include communications over CDMA, GSM, and/or GPRS networks, often used by cellular phone and mobile data providers in communicating with their consumers 302.

In another exemplary embodiment, the hand-held device 566 can comprise a transmitter/receiver 568 that can transmit and receive data 120 to and from an information processing unit, such as a client computer 340 comprising a transmitter/receiver (not shown), wherein the information processing unit can transmit and receive data 120 to and from the server computer 108 via the network 114, such as the internet.

In step 1125, the identity of the used product 126 is determined, based upon the data 120 corresponding with the bar code of the used product 126 and a bar code guide 350. In exemplary embodiments, the bar code guide 350 can comprise a database that includes a listing of bar codes and the corresponding products 126 with which those bar codes are associated. For example, the bar code guide 350 can comprise a data 120 entry that indicates that the bar code “123456” corresponds with Brand X Orange Juice. In certain embodiments, the bar code guide 350 can comprise data 120 entries that also indicate the size and other packaging information corresponding with a given bar code.

In exemplary embodiments, after the bar code associated with a product 126 is transmitted to the server computer 108, the server computer 108 can retrieve the bar code guide 350, and search through the bar code guide 350 to determine the product 126 that corresponds with the bar code.

In step 1130, a list of products 126 is transmitted to the consumer 302, the list being based on the identity of the used product 126. In exemplary embodiments, the list of products 126 can comprise one or more of the following types of products 126: (1) the used product 126, (2) products 126 that compete with the used product 126, and (3) products 126 that complement the used product 126. For example, if the used product 126 is Brand A hamburgers, the list of products 126 can comprise Brand A hamburgers, Brand B hamburgers, Brand A ketchup, and Brand C hamburger buns.

In certain embodiments, the list of products 126 can be transmitted to the consumer's 302 hand-held device 566 via a network 114, such as the internet. In particular embodiments, the list of products 126 can be received by the wireless internet transmitter/receiver 568 of the hand-held device 566, and then transmitted to the processor 574 for display on the hand-held device 566.

In step 1135, the consumer 302 selects the desired product 126 from the list of products 126. In exemplary embodiments, once the list of products 126 is transmitted to the hand-held device 566, the processor 574 then can convert the list of products 126 into a form that can be displayed on the hand-held device's 566 screen 576, and then the hand-held device's 566 screen 576 can display the list of products 126 to the consumer 302. The consumer 302 then can select the desired product 126 from the list of products 126 by utilizing an interactive keypad 570 that can be part of the hand-held device 566 in certain embodiments.

In step 1140, data 120 corresponding with the desired product 126 is transmitted to the server computer 108. In exemplary embodiments, the wireless internet transmitter/receiver 568 of the hand-held device 566 can transmit the data 120 to the server computer 108 via a network 114, such as the internet.

In certain embodiments, data 120 corresponding with the desired product 126 can be transmitted immediately after the consumer 302 selects the desired product 126 from the list of products 126. In alternative embodiments, the data 120 corresponding with the desired product 126 can be stored on the hand-held device 566, and combined with data 120 corresponding with other desired products 126, and then transmitted to the server computer 108 at a later time. For example, in these embodiments, the data 120 corresponding with desired products 126 can be transmitted to the server computer 108 periodically. In exemplary embodiments, the data 120 corresponding with desired products 126 can be stored on the hand-held device 566 and then transmitted to the server computer 108 at a time before the consumer 302 wishes to have all ordered products 126 delivered.

In step 1145, data 120 corresponding with the desired product 126 is added to the consumer's 302 order. This step 1145 can comprise retrieving order data 122 indicating the products 126 ordered by the consumer 302 that have not been delivered to the consumer 302, adding the desired product data 120 to this order data 122, and then storing the updated order data 122 in a data storage center 110. The method 910 then proceeds to step 810.

FIG. 12 is a flow chart depicting a method 920 for receiving order data 122 based upon a product search according to an exemplary embodiment, as referenced in step 920 of FIG. 9. The method 920 will be described with reference to FIGS. 1-7 and 12.

In step 1205, the method 920 determines if the consumer 302 corresponding with the order data 122 is registered as described above with reference to step 1105 of FIG. 11. If the consumer 302 is not registered, the method 920 proceeds to step 1110, where the consumer 302 is registered. After step 1110, which will be discussed in more detail with reference to FIG. 16, the method 920 proceeds to step 1210. Step 1210 also is reached directly if the method 920 determined in step 1205 that the consumer 302 was registered.

In step 1210, a consumer 302 selects a desired product 126. In exemplary embodiments, the consumer 302 can select the desired product 126 by utilizing a hand-held device 566 comprising an interactive keypad 570, a screen 576, and a wireless internet transmitter/receiver 568 for communicating data 120 with a server 108 over a network 114 such as the internet.

In certain embodiments, the interactive keypad 570 can comprise alphanumeric characters that can be utilized by the consumer 302 to type one or more words that describe the desired product 126. In other embodiments, the interactive keypad 570 can comprise a selection mechanism, wherein the consumer 302 can select certain categories of products 126 and then certain subcategories of those categories, until the consumer 302 can select the desired product 126.

In step 1215, data 120 corresponding with the desired product 126 selected in step 1210 is transmitted to the server computer 108. In exemplary embodiments, the hand-held device 566 also can comprise a processor 574 that can generate the data 120 that corresponds with the selected product 126. The hand-held device 566 then can utilize a wireless internet transmitter/receiver 568 to transmit the data 120 to a server computer 108 via a network 114 such as the internet.

In step 1220, a product listing is searched for products 126 that match the data 120 corresponding with the desired product 126. In certain embodiments, the product listing can comprise data 120 that includes a description of some or all of the products 126 that can be ordered by a consumer 302. The description can comprise categories and/or subcategories indicating the type of product 126, the brand name of the product 126, and other identifying characteristics of each product 126.

In certain embodiments, the product listing can be stored in a data storage center 110. The server computer 108 then can retrieve the product listing from the data storage center 110 and then search the product listing for products 126 that match the data 120 corresponding with the desired product 126.

In step 1225, data 120 indicating some or all of the products 126 that match the desired product data 120 is transmitted to the consumer 302. In exemplary embodiments, the hand-held device 566 receives the data 120 indicating the matching products 126 with the wireless internet transmitter/receiver 568.

In exemplary embodiments, the hand-held device 566 can comprise the product listing stored in a memory. For example, the server compute 108 can communicate the product listing to the hand-held device 566 via the network 114. In such embodiments, data 120 corresponding with the desired product 126 need not be transmitted to the server computer 108 as shown in step 1215. Rather, the hand-held device 566 can search the product listing for products 126 that match the desired product data 120, as shown in step 1220. In these embodiments, transmitting matching products 126 from the server computer 108 to the consumer 302, as shown in step 1225, is likewise not required.

In step 1230, the consumer 302 selects the product 126 from the matching products 126 to order the selected product. In exemplary embodiments, once the matching product data 120 is transmitted to the hand-held device 566, the processor 574 then can convert the matching product data 120 into a form that can be displayed on the hand-held device's 566 screen 576, and then the hand-held device's 566 screen 576 can display the matching products 126 to the consumer 302. The consumer 302 then can select the product 126 to order from the matching products 126 by utilizing the interactive keypad 570.

In step 1235, data 120 corresponding with the selected product 126 is transmitted to the server computer 108. In exemplary embodiments, the wireless internet transmitter/receiver 568 of the hand-held device 566 can transmit the data 120 to the server computer 108 via a network 114 such as the internet.

In step 1240, data 120 corresponding with the selected product 126 is added to the consumer's 302 order. This step 1240 can comprise retrieving order data 122 indicating the products 126 ordered by the consumer 302 that have not been delivered to the consumer 302, adding the selected product data 120 to this order data 122, and then storing the updated order data 122 in a data storage center 110. The method 920 then proceeds to step 810.

FIG. 13 is a flow chart depicting a method 930 for receiving order data 122 based upon a response to a promotion 130 according to an exemplary embodiment, as referenced in step 930 of FIG. 9. The method 930 will be described with reference to FIGS. 1-7 and 13.

In step 1305, the method 930 determines if the consumer 302 corresponding with the order data 122 is registered as described above with reference to step 1105 of FIG. 11. If the consumer 302 is not registered, the method 930 proceeds to step 1110, where the consumer 302 is registered. After step 1110, which will be discussed in more detail with reference to FIG. 16, the method 930 proceeds to step 1310. Step 1310 also is reached directly if the method 930 determined in step 1305 that the consumer 302 was registered.

In step 1310, the method 930 determines if a promotion 130 is available for the consumer 302. If a promotion 130 is not available for the consumer 302, the method 930 proceeds to step 805 shown in FIG. 8. If a promotion 130 is available, the method 930 proceeds to step 1315. As used herein, a “promotion” refers to any enticement offered to a consumer 302 to encourage the consumer 302 to purchase a given product 126. Common examples of promotions 130 can include a reduced price for a product 126, a free sample of a product 126, a coupon, and a buy-one-get-one-free offer. The promotions can be for a product selected or otherwise identified by the consumer 302 or for a product that competes with and/or complements the product selected or otherwise identified by the consumer 302.

In exemplary embodiments, companies 112 can offer promotions 130 to consumers 302 to entice them to purchase certain products 126. Companies 112 that offer these promotions 130 can include manufacturers of products 126 who offer promotions 130 to consumers 302 to entice them to purchase products 126 manufactured by the company 112. Companies 112 offering promotions 130 also can include stores 106, who can offer promotions 130 to consumers 302 to entice them to purchase any product 126 sold by the store 106.

Companies 112 can decide whether to offer promotions 130 based upon many factors. In certain embodiments, companies 112 can offer promotions 130 to all consumers 302 or select consumers 302 at random. In other embodiments, companies 112 can offer promotions 130 to consumers 302 who have already purchased products 126 from the company 112. In still other embodiments, companies 112 can offer promotions 130 to consumers 302 who regularly purchase products 126 from the company's 112 competitors. In other embodiments, companies 112 can offer promotions 130 to consumers 302 based upon consumer data 124 such as demographic data 120 and/or television viewing data 120. Companies 112 can receive data 120 comprising the products 126 consumers 302 have purchased, demographic data 120, and television viewing data 120 through different methods. Examples of such methods will be discussed in more detail with reference to FIG. 10.

In step 1315, data 120 indicating the promotion 130 available to the consumer 302 is transmitted to the consumer 302. In certain embodiments, more than one promotion 130 can be available to the consumer, and in such embodiments, data 120 indicating all of the promotions 130 can be transmitted to the consumer 302. In exemplary embodiments, the promotion 130 data 120 can be transmitted from the company 112 offering the promotion 130 to the consumer 302. In certain embodiments, the promotion 130 data 120 can be transmitted to the consumer 302 via any type of media 128, such as television 342. In other embodiments, the promotion 130 data 120 can be transmitted from the company 112 to the server computer 108 via a network 118 such as the internet, and then from the server computer 108 to the consumer 302 via a network 114.

In exemplary embodiments, the promotion 130 data 120 can be transmitted to the consumer's 302 hand-held device 566. The hand-held device 566 can comprise the features described above, such as a bar code scanner 338, a processor 574, a screen 576, an interactive keypad 570, and a wireless internet transmitter/receiver 568. The wireless internet transmitter/receiver 568 can receive the promotion 130 data 120 and transmit the promotion 130 data 120 to the processor 574, which can convert the data 120 into a form that can be displayed by the screen 576.

In step 1320, the method 930 determines whether the consumer 302 accepts the promotion 130. If the consumer 302 does not accept the promotion 130, the method 930 proceeds to step 805, shown in FIG. 8. If the consumer 302 accepts the promotion 130, the method 930 proceeds to step 1325. In exemplary embodiments, the consumer 302 can indicate a desire to accept or reject the promotion 130 by utilizing the interactive keypad 570.

In certain embodiments, a promotion 130 available for a consumer 302 can comprise an interactive advertisement. For example, an advertisement can be presented to the consumer 302 via the television 342. Then a question about the advertisement can be presented to the consumer 302 via the hand-held device 566. The consumer 302 can utilize the hand-held device 566 to respond to the question. If the consumer 302 answers the question correctly, the consumer 302 can receive an enticement to purchase the advertised product 126.

In certain embodiments, another promotion 130 available for a consumer 302 can comprise a “scavenger hunt.” As used herein, a “scavenger hunt” refers to a specific type of promotion 130 wherein a consumer 302 can receive an enticement if the consumer 302 can indicate that the consumer 302 owns a certain product 126. For example, Brand E can offer a scavenger hunt to one or more consumers 302 wherein the consumers 302 can receive a discount on future Brand E milk purchases if they can indicate within a certain period of time that they already own Brand E milk.

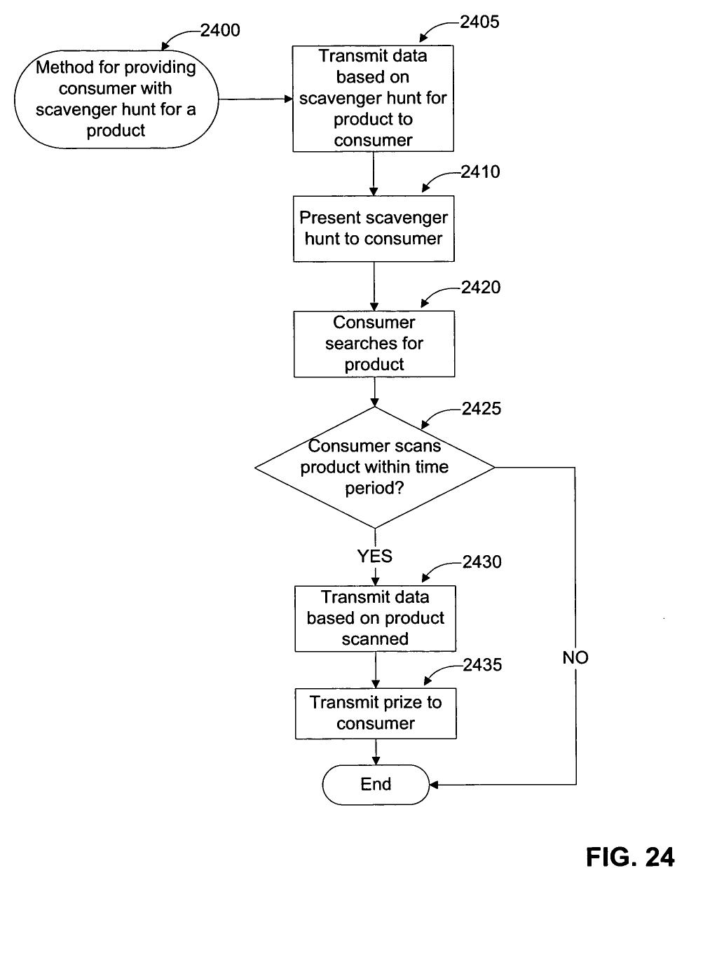

In exemplary embodiments, consumers 302 participating in scavenger hunts who own the relevant product 126 can scan the bar code of the relevant product 126 as proof that they own the product 126. In exemplary embodiments, the consumer 302 can scan the bar code of the relevant product 126 and transmit data 120 corresponding with the bar code by utilizing a hand-held device 566 comprising a bar code scanner 338, a screen 576, and a wireless internet transmitter/receiver 568 for communicating data 120 with a server 108 over a network 114 such as the internet. For these embodiments, acceptance of the scavenger hunt promotion 130 can comprise scanning the bar code of the relevant product 126. Scavenger hunts are discussed in more detail with reference to FIG. 24.

In step 1325, data 120 based upon the accepted promotion 130 is transmitted to the server computer 108. The data 120 transmitted to the server computer 108 can comprise data 120 indicating the promotion 130 offered to the consumer 302 and data 120 indicating that the consumer 302 wishes to accept the promotion 130.

In step 1330, data 120 indicating the product 126 corresponding with the accepted promotion 130 is added to the consumer's 302 order. This step 1330 can comprise determining the product 126 corresponding with the promotion 130, retrieving order data 122 indicating the products 126 ordered by the consumer 302 that have not been delivered to the consumer 302, adding the data 120 indicating the product 126 corresponding with the accepted promotion 130 to the order data 122, and then storing the updated order data 122 in a data storage center 110. In an exemplary embodiment, the price for the ordered product can reflect the promotion, such as a discounted price, a coupon-reduced price, or a two-for-one price. The method 930 then proceeds to step 810.

FIG. 24 is a flow chart depicting a method 2400 for providing a consumer 302 with a scavenger hunt promotion 130 for a product 126 according to an exemplary embodiment. The method 2400 will be described with reference to FIGS. 1-7 and 24.

In step 2405, data 120 based upon a scavenger hunt promotion 130 is transmitted to the consumer 302. In exemplary embodiments, the promotion 130 is transmitted from a company 112 to the server computer 108 via a network 118, and then from the server computer 108 to the consumer 302 via a network 114. In certain embodiments, the consumer's 302 hand-held device 566 can receive the data 120 transmitted via the wireless internet transmitter/receiver 568. The data 120 can comprise the identity of a product 126 for the consumer 302 to locate and a time period in which to locate the product 126.

In step 2410, the scavenger hunt is presented to the consumer 302. In certain embodiments, the processor 574 of the consumer's 302 hand-held device 566 can convert the data 120 into a form that can be displayed by the screen 576 of the device 566.

In step 2420, the consumer 302 searches for the product 126. In exemplary embodiments, the consumer 302 can search within the home 102 for the product 126. In certain embodiments, once the consumer 302 finds the product 126, the consumer 302 can scan the bar code of the product 126 with the hand-held device's 566 bar code scanner 338.

In step 2425, the method 2400 determines if the consumer 302 scanned the product 126 within the time period allowed by the scavenger hunt promotion 130. If the consumer 302 did not scan the bar code of the product 126 within the allowed time period, the method 2400 ends. If the consumer 302 did scan the bar code of the product 126 within the allowed time period, the method 2400 proceeds to step 2430.

In step 2430, data 120 based on the product 126 scanned by the consumer 302 is transmitted. In exemplary embodiments, the hand-held device 566 can transmit the data 120 to the server computer 108 via a network 114. In certain embodiments, the server 108 can determine if the product 126 scanned was the product 126 to be scanned according to the scavenger hunt.

In step 2435, a prize for completing the scavenger hunt is transmitted to the consumer 302. In exemplary embodiments, the prize can comprise another promotion 130 such as coupon for a discounted price. The method 2430 then ends.

FIG. 14 is a flow chart depicting a method 935 for receiving order data 122 based upon a product 126 shown on television 342 according to an exemplary embodiment, as referenced in step 935 of FIG. 9. The method 935 will be described with reference to FIGS. 1-7 and 14.

In step 1405, the method 935 determines if the consumer 302 corresponding with the order data 122 is registered as described above with reference to step 1105 of FIG. 11. If the consumer 302 is not registered, the method 935 proceeds to step 1110, where the consumer 302 is registered. After step 1110, which will be discussed in more detail with reference to FIG. 16, the method 935 proceeds to step 1410. Step 1410 is also reached directly if the method 935 determined in step 1405 that the consumer 302 was registered.

In step 1410, a consumer 302 indicates a desire to purchase a product 126 that is currently shown on television 342. In exemplary embodiments, the consumer 302 can indicate this desire by utilizing the interactive keypad 570 of a hand-held device 566 as described above. In particular embodiments, the interactive keypad 570 can include a key that, when pressed by the consumer 302, indicates a desire to purchase a product 126 that is currently shown on television 342. In certain embodiments, the hand-held device 566 can comprise an interactive keypad 570, a screen 576, and a wireless internet transmitter/receiver 568 for communicating data 120 with a server 108 over a network 114 such as the internet.

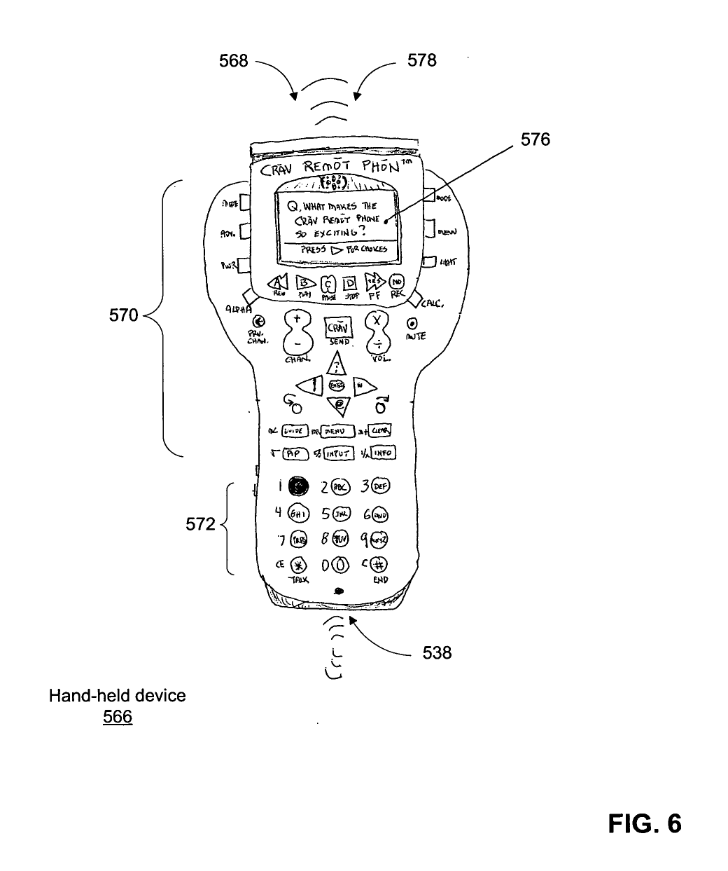

In one exemplary embodiment, the hand-held device 566 can be designed in a compact form factor resembling a remote control and allowing one-handed operation of the device 566. A hand-held device 566 in this form factor according to one embodiment is shown in FIG. 6. Additionally, the hand-held device 566 in exemplary embodiments can comprise features associated with standard remote controls. Specifically, the hand-held device 566 can comprise a channel control keypad 572 and transmitter 578 for operating a television 342 and/or other household electronic devices. In exemplary embodiments, the size and shape of the hand-held device 566 can be similar to the size and shape of standard remote controls. In further exemplary embodiments, the hand-held device 566 can be ergonomically designed to fit comfortably in one hand of the operator and can allow one-handed operation.

The remote control form factor and functionality of the hand-held device 566 can allow consumers 302 utilizing the device 566 to replace other remote controls with the hand-held device 566, as people often do by utilizing a “universal” remote control. Remote controls are differentiated in retail outlets and in the mind of consumers, and have earned a distinctive position as a device within the television 342 viewing venue. Because people are either right handed or left handed, one and only one device can earn the right to be the “palm habitant” while experiencing television 342, as the mouse has done in the computer environment. Also, there is an entire sub-industry of replacement remote controls in which the hand-held device 566 would qualify for consideration. A laptop or personal digital assistant however would not qualify as such a replacement because of their form factor. There is a science to migrating applications to a remote control form factor so as to win the sole right to control the palm of the television 342 viewer; the form factor of the hand-held device 566 takes this science into account.

In step 1415, data 120 indicating a desire to purchase a product 126 currently shown on television 342, the time the consumer 302 indicated the desire to purchase the product 126, and the channel the consumer 302 was watching when indicating the desire to purchase the product 126 is transmitted to the server computer 108. In exemplary embodiments, these products 126 shown in the content 346 can include advertised products 126 as well as product placements, or products 126 shown on programming other than advertising.

Various techniques exist for determining the channel watched by the consumer 302 when indicating a desire to purchase the product 126. In exemplary embodiments, the hand-held device 566, functioning as a remote control, can store the most recent channel set by the consumer 302. In these embodiments, the hand-held device 566 can track the channel watched by the consumer 302 at any time, because whenever the channel is changed by the consumer 302 utilizing the hand-held device 566, the device 566 updates the current channel setting to reflect the change. In such embodiments, the hand-held device 566 can transmit the current channel setting to the server computer 108 as part of step 1415.

In alternative embodiments, a consumer 302 can watch television 342 through a set-top box (“STB”). As used herein, an “STB” refers to a receiver or any processing unit that can receive and process content 346 transmitted from a content provider 344 and transmit the processed content 346 as an audio and video signal to a television 342 or other monitor. The set-top box can be in a separate housing which physically sits on top of a television 342, it can be in some other location external to the television 342 and in communication with the television 342, or it can be built into the television 342 itself.

In embodiments wherein the consumer 302 watches television 342 through an STB, the STB can track the current channel setting at all times. In such embodiments, when the consumer 302 indicates a desire to purchase the product 126 shown on television 342, the STB can transmit the current channel setting to the server computer 108. In certain embodiments, the STB can transmit the current channel setting to the server computer 108 via a network such as the internet. Alternatively, the hand-held device 566 can comprise a receiver that can receive the current channel setting from the STB, and then transmit the current channel setting to the server computer 108 via the device's 566 wireless internet transmitter/receiver 568.

In step 1420, the identity of the product 126 shown on television 342 that the consumer 302 indicated a desire to purchase in step 1410 is determined, based upon the time and channel setting transmitted in step 1415 and a programming guide 348. As used herein, a “programming guide” refers to data 120 that indicates the content 346 shown on channels that can be received by the consumer 302. Programming guides 348 can be specific to the content provider 344 that provides content 346 to the consumer 302. As used herein, “content” can refer to all programming provided by the content provider 344, including scheduled television 342 programming and commercial messages.

In exemplary embodiments, programming guides 348 for consumers 302 can be stored in a data storage center 110 and associated with the corresponding consumers 302. In certain embodiments, the programming guides 348 can be transmitted to the data storage center 110 via the server computer 108 from a content provider 344. In other embodiments, the programming guides 348 can be input manually.

In certain embodiments, the data storage center 110 may not comprise the programming guide 348 corresponding with the consumer 302. In such embodiments, the server computer 108 can retrieve a programming guide 348 in step 1420, and then search the programming guide 348.

In exemplary embodiments, the server computer 108 can receive the time and channel setting transmitted in step 1415. The server computer 108 also can retrieve from the data storage center 110 the programming guide 348 associated with the consumer 302. The server computer 108 then can search the programming guide 348 to determine the programming shown.

In certain embodiments, the sever computer then can determine the product 126 shown on television 342 that the consumer 302 indicated a desire to purchase in step 1410. In exemplary embodiments, the programming guide 348 comprises a listing of the products 126 shown (via advertisements or product placement) on each channel at any given time. In such embodiments, the server computer 108 can determine the appropriate product 126 shown on television 342 by searching the programming guide 348.

In exemplary embodiments, data 120 indicating the determined product 126 can be transmitted to the consumer 302 to confirm that the determined product 126 matches the product 126 the consumer 302 desired to purchase. In certain embodiments, data 120 indicating more than one product 126 can be transmitted to the consumer 302 if the server computer 108 determined that multiple products 126 were shown on the relevant channel and time. Data 120 indicating more than one product 126 also can be transmitted to the consumer 302 if the determined product 126 is available in multiple sizes or forms. In these embodiments, the hand-held device 566 can receive the data 120 indicating the determined products 126 with the wireless internet transmitter/receiver 568, and the consumer 302 can select a determined product 126 to purchase from the multiple determined products 126.

In step 1425, data 120 corresponding with the determined product 126 is added to the consumer's 302 order. This step 1425 can comprise retrieving order data 122 indicating the products 126 ordered by the consumer 302 that have not been delivered to the consumer 302, adding the selected product data 120 to this order data 122, and then storing the updated order data 122 in a data storage center 110. The method 935 then proceeds to step 810.

FIG. 16 is a flow chart depicting a method 1110 for registering a consumer 302 according to an exemplary embodiment, as referenced in step 1110 of FIGS. 11-14. The method 1110 will be described with reference to FIG. 1-7 and 16.

In step 1605, a consumer 302 is prompted for demographic information. As used herein, “demographic information” refers to characteristics of a population, sample, or individual, including but not limited to race, ethnicity, gender, age, religion, income level, educational background, profession, and geographic location. In different embodiments, various methods exist for prompting the consumer 302 for such information. For example, the data 120 corresponding with the prompt can be transmitted from the server computer 108 to the consumer's 302 hand-held device 566 via a network 114 such as the internet, and then the hand-held device 566 can display the prompt to the consumer 302 The consumer 302 then can utilize the interactive keypad 570 to input demographic information in response to the prompts. Alternatively, the consumer 302 can be prompted for demographic information via a website.

In exemplary embodiments, the consumer 302 can be prompted for information other than demographic information. Such other information can include the local store 234 from which the consumer 302 plans on receiving ordered products 126, credit card information for payment of applicable charges, or other suitable information.

In step 1610, the demographic information input by the consumer 302 in step 1605 is retrieved. In exemplary embodiments, the server computer 108 can retrieve the demographic information and any other information input by the consumer 302.

In step 1615, the method 1110 determines whether the consumer 302 will share historical data 120. In certain embodiments, historical data 120 can include historical shopping orders. In exemplary embodiments, the consumer 302 can be a member of a loyalty program with another store, wherein the other store tracks the purchases made by the consumer 302 at the store in exchange for discounted prices and other promotions 130. In these embodiments, the consumer 302 authorizes the home grocery delivery provider to retrieve the consumer's 302 historical order data 122 from the administrator of the loyalty program. The home grocery delivery provider also may need to acquire permission from the administrator of the loyalty program to retrieve such information.

In exemplary embodiments, historical data 120 can include data not related to historical shopping orders. For example, historical data 120 can include historical television viewing data 120.

In certain embodiments, the consumer 302 can be prompted to indicate whether the consumer 302 wishes to share historical data 120. In exemplary embodiments, the consumer 302 also can be prompted to indicate the different types of historical data 120, if any, the consumer 302 wishes to share.

If the consumer 302 does not share any historical data 120, the method 1110 proceeds to step 1625. If the consumer 302 shares historical data 120, the method 1110 proceeds to step 1620.

In step 1620, the historical data 120 provided by the consumer 302 is retrieved. In exemplary embodiments, the consumer 302 can be prompted for historical data 120 and the historical data 120 input by the consumer 302 can be retrieved according to various techniques, including those described above for retrieving demographic information from the consumer 302.

In step 1625, the consumer data 124 input by the consumer 302, including demographic information and historical data 120, is associated with an identifier unique to the consumer 302. In exemplary embodiments, the identifier can comprise any data 120 that can be associated with consumer data 124 and order data 122 stored in a data storage center 110 that corresponds with the consumer 302. Examples of identifiers include consumer numbers and account numbers. In certain embodiments, the consumer's 302 social security number, if provided by the consumer 302, can serve as the identifier.

In step 1630, the consumer data 124 retrieved from the consumer 302 and the identifier are stored. In exemplary embodiments, the identifier is associated with the consumer data 124 and stored in the data storage center 110 with the consumer data 124.

In exemplary embodiments, a consumer 302 can gain certain privileges after completing the registration process. For example, a consumer 302 can view order history and upcoming orders via the hand-held device 566 or a website interface. The consumer 302 also can set a password to protect the consumer's 302 account from unauthorized access.

The method 1110 then proceeds to one of the steps 1115, 1210, 1310, or 1410, depending on which step in FIGS. 11-14 resulted in the method 1110 being performed.

FIG. 10 is a flow chart depicting a method 810 for processing and delivering a consumer 302 order according to an exemplary embodiment, as referenced in step 810 of FIG. 8. The method 810 will be described with reference to FIGS. 1-7 and 10.

In step 1005, the order received from a consumer 302 in step 805 of FIG. 8 is delivered to the consumer 302. In exemplary embodiments, the order can comprise one or more products 126 ordered by the consumer 302 for delivery. Order data 122 can be transmitted from a server computer 108 to a store 106 via a network 116 such as the internet. In exemplary embodiments, the store 106 can be a hub store 232, a local store 234, or an affiliated store 106. The store 106 then can deliver the products 126 to the consumer's 302 home 102 via a delivery vehicle 104. In certain embodiments, the delivery vehicle 104 can comprise a refrigerated compartment that can store perishable products 126 while en route to the consumer's 302 home 102.

In exemplary embodiments, the consumer 302 can be charged for the products 126 to deliver to the consumer's 302 home 102 before, while, or after the delivery. In exemplary embodiments, the consumer 302 can pay for the products 126 with a credit card. In some embodiments, the hand-held device 566 can comprise a credit card reader, and then consumer 302 can scan his or her credit card with the hand-held device 566 to pay for the ordered products 126. In other embodiments, the consumer 302 can provide a credit card number when the consumer 302 registers. Registration of consumers 302 is discussed in more detail with reference to FIG. 16.

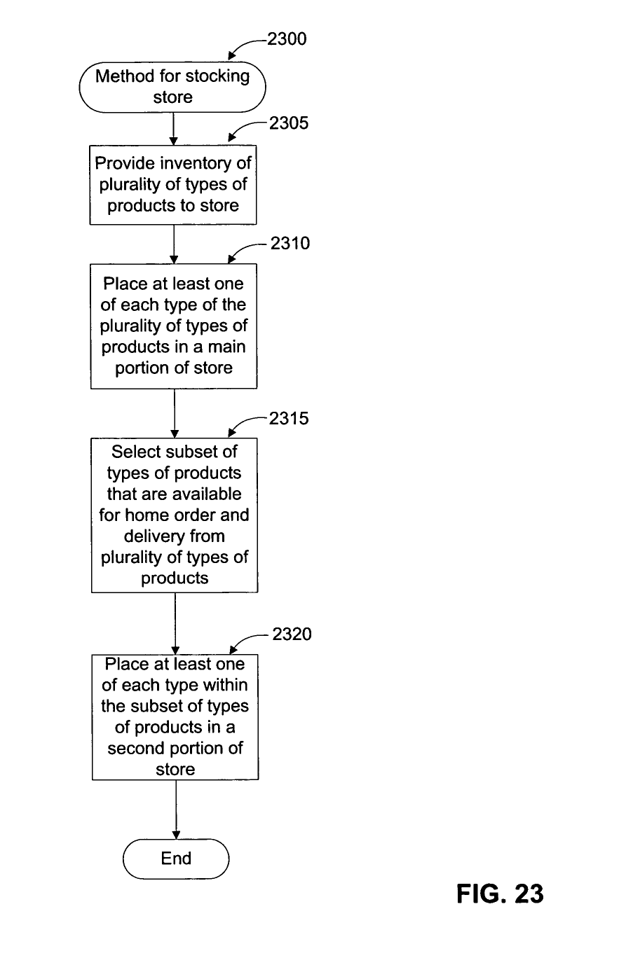

In certain embodiments, the fees charged to the consumer 302 for ordering products 126 for home delivery can vary based on several factors. Fees can be higher for products 126 that need to be transported from another store to the consumer's 302 local store 234. Additionally, delivery fees can be higher for smaller consumer 302 orders. Fees can be lower for QwikShop products 126, or those within a subset of the inventory of products 126 as discussed in more detail with respect to FIG. 23.

In exemplary embodiments, fees can vary depending on consumer 302 preferences regarding data 120 sharing. Consumers 302 who provide greater amounts of consumer data 124 such as demographic information, order history, and/or television viewing data 120 can receive discounted fees.

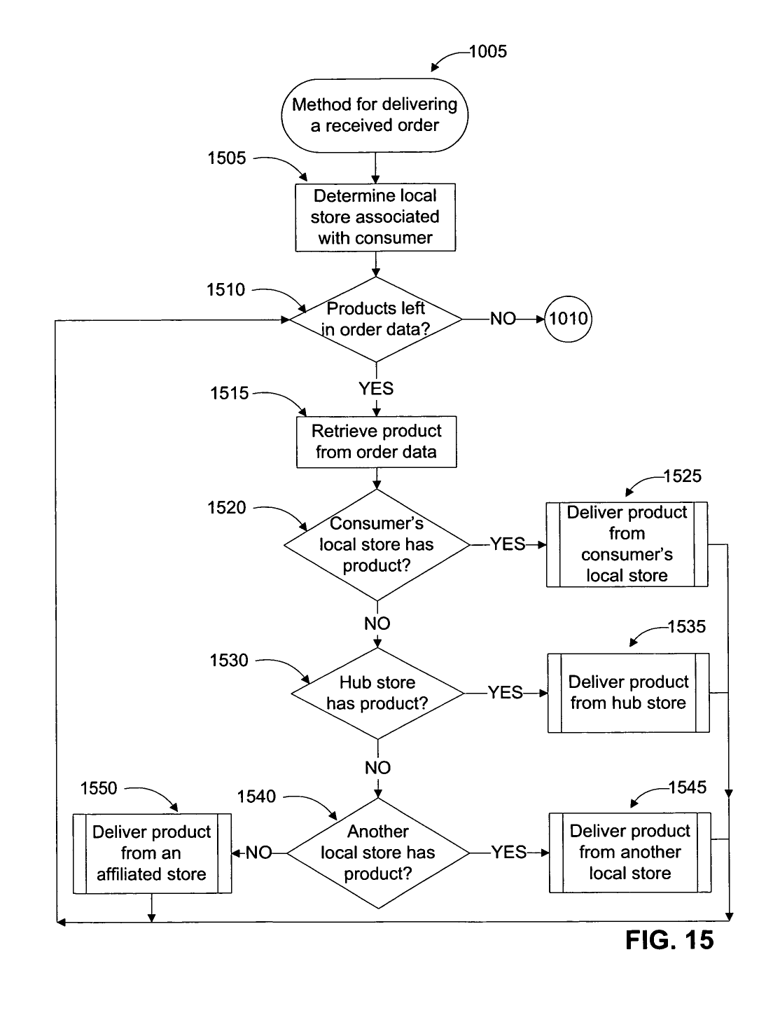

The variable fee structure that can be included in certain embodiments can help offset the problem of high costs associated with traditional home grocery delivery models. Step 1005 will be discussed in more detail with reference to FIG. 15.

In step 1010, consumer data 124 associated with the consumer 302 who placed the order is retrieved with the server computer 108. In exemplary embodiments, a data storage center 110 can comprise consumer data 124. Consumer data 124 can comprise a consumer's 302 demographic information, past order history, and television viewing data 120. Other types of information also can be included as consumer data 124. In certain embodiments, the types of information stored as consumer data 124 can depend on preferences indicated by the consumer 302 when registering for home grocery delivery. Consumer 302 registration is discussed in more detail with reference to FIG. 16.

In step 1015, the retrieved consumer data 124 is updated to include the order data 122 indicating the contents of the consumer's 302 order. In exemplary embodiments, the updated consumer data 124 can be transmitted to the data storage center 110 and stored.

In step 1020, the updated consumer data 124 is provided to companies 112. In exemplary embodiments, companies 112 can include any entity interested in acquiring the consumer data 124. In certain embodiments, such companies 112 can include manufacturers of products 126 offered for home delivery and order to consumers 302. Consumer data 124 can be provided to companies 112 via a network 118 such as the internet.

Companies 112 can utilize the consumer data 124 for various purposes. In certain embodiments, companies 112 can utilize the consumer data 124 to determine the consumers 302 to which to send promotions 130, as discussed above with reference to step 1310 of FIG. 13.

Likewise, in certain embodiments, companies 112 can utilize the consumer data 124 to determine the consumers 302 to which to send personalized advertisements. As used herein, “personal advertisements” refer to advertisements presented to a determined audience of consumers 302. In particular embodiments, companies 112 can present personal advertisements to a consumer 302 via the content provider 344 to which the consumer 302 subscribes.

In other embodiments, companies 112 can utilize the consumer data 124 to determine the value of advertising more accurately and determine optimal advertising placement. In these embodiments, companies 112 can analyze the demographic data 120, past order history, and television viewing data 120 to determine the typical products 126 purchased and television 342 programming watched by different types of consumers 302. For example, analyzing the consumer data 124 can indicate that one million consumers 302 with an annual income above $75,000 watch Television Show XYZ every week and purchase gourmet coffee regularly. Company F, which manufacturers Brand F gourmet coffee can receive this information, and decide that advertising for Brand F gourmet coffee during Television Show XYZ could generate more revenue than Company F would have thought absent this information.

In still other embodiments, companies 112 can utilize the consumer data 124 to determine the efficacy of advertisements shown to consumers 302. In these embodiments, companies 112 can analyze the past order history and television viewing data 120 to determine the percentage of consumers 302 who watched a given advertisement and then purchased the advertised product 126 soon thereafter. In exemplary embodiments, the companies 112 also can analyze the data 120 to determine the if a given advertisement caused new consumers 302 to purchase the advertised products 126. For example, Company F, after advertising its gourmet coffee during Television XYZ, can analyze the order history of consumers 302 who watched Television Show XYZ when the advertisement was shown. Company F can determine from this data 120 how many consumers 302 purchased Brand F gourmet coffee within a predetermined time period after watching the advertisement. Company F also can determine how many of these consumers 302 were regular purchasers of Brand F gourmet coffee before the advertisement aired, and how many of the consumers 302 had previously been regular purchasers of a competitor's gourmet coffee.

In step 1025, promotions 130 based upon consumer data 124 are retrieved from companies 112. In exemplary embodiments, companies 112 can transmit data 120 indicating promotions 130 and the consumers 302 selected to receive the promotions 130 to the server computer 108 via networks 118 such as the internet. The promotions 130, as described above with reference to FIG. 13, can comprise various enticements for purchasing a product 126 or a product that competes with and/or complements the product 126, such as a reduced price or a free sample.

In step 1030, promotions 130 can be transmitted to the selected consumers 302, as described in more detail in step 1315 of FIG. 13. The method 810 then proceeds to step 815.

FIG. 15 is a flow chart depicting a method 1005 for delivering an order received in step 805 of FIG. 8 according to an exemplary embodiment, as referenced in step 1005 of FIG. 10. The method 1005 will be described with reference to FIGS. 1-7 and 15.

In step 1505, the local store 234 associated with the consumer 302 is determined. In exemplary embodiments, the invention can comprise a set of related stores 200. The set of related stores 200 can comprise a hub store 232 and a number of local stores 234A-D. In certain embodiments, the set of related stores 200 can comprise only one hub store 232. In other embodiments, the set of related stores 200 can comprise multiple hub stores 232. In exemplary embodiments, hub stores can comprise products 126 that are non-perishable, whereas local stores 234A-D can comprise perishable and non-perishable products 126. Each local store 234A-D can serve a number of consumers' 302 homes 102A, 102B, 102N, as shown in FIG. 1.

In certain embodiments, each home 102, local store 232, and hub store 234 can be in informational communication with a server computer 108. The informational communication can be via a network 116 such as the internet. In exemplary embodiments, the server computer 108 can have immediate and dynamic information relative to all items on the cumulative order lists of all consumers 302, for each day, as well as tools to manage deliveries based upon locations, delivery staff management tools, and tools that enable in-store promotions 130 to be added, to assist in the sale of approved, targeted items. This in-store promotion 130 software can have its own registration and security settings, to prevent the unauthorized insertion of promotions 130 or discounts.

In exemplary embodiments, the server computer 108 can determine the consumer 302 based upon the order data 122 indicating the received order. The server computer 108 also can determine the local store 234 associated with the consumer 302 based upon the consumer data 124. In certain embodiments, consumers 302 can indicate their local store 234 when registering for home grocery delivery. Consumer 302 registration is discussed in more detail with reference to FIG. 16.

In step 1510, the method 1005 determines if there are products 126 left in the order received in step 805 of FIG. 8. If a product 126 is not remaining in the order then the method 1005 proceeds to step 1010 of FIG. 10. If at least one product 126 remains in the order, the method 1005 proceeds to step 1515.

In step 1515, data 120 corresponding with one product 126 from the order is retrieved. In exemplary embodiments, the server computer 108 retrieves data 120 corresponding with one product 126 in the order.

In step 1520, the method 1005 determines if the consumer's 302 local store 234 has the product 126. In exemplary embodiments, the server computer 108 can transmit data 120 corresponding with the product 126 to the consumer's 302 local store's 234 information processing unit 460. The information processing unit 460 then can determine whether the local store 234 has the product 126. In exemplary embodiments, the determination can comprise determining whether the local store 234 offers the product 126 for sale generally and determining whether the local store 234 has the product 126 in stock. In certain embodiments, the information processing unit 460 can comprise software to help track inventory. In a particular embodiment, the information processing unit 460 can be in informational communication with a loading dock and cash registers located in the check-out section 458, and inventory software can update the inventory in real time as products 126 are entering and exiting the store 234 through incoming deliveries and purchases, respectively.

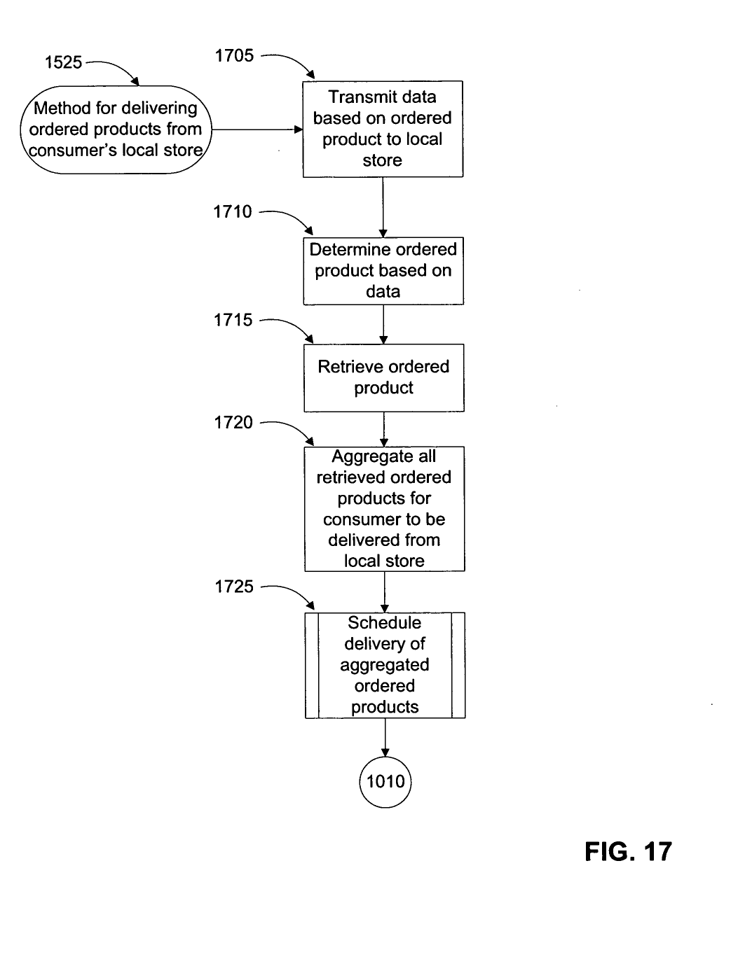

If the consumer's 302 local store 234 has the product 126, the method 1005 proceeds to step 1525, where the product 126 is delivered to the consumer 302 from the consumer's 302 local store 234. After step 1525, which will be discussed in more detail with reference to FIG. 17, the method 1005 returns to step 1510.

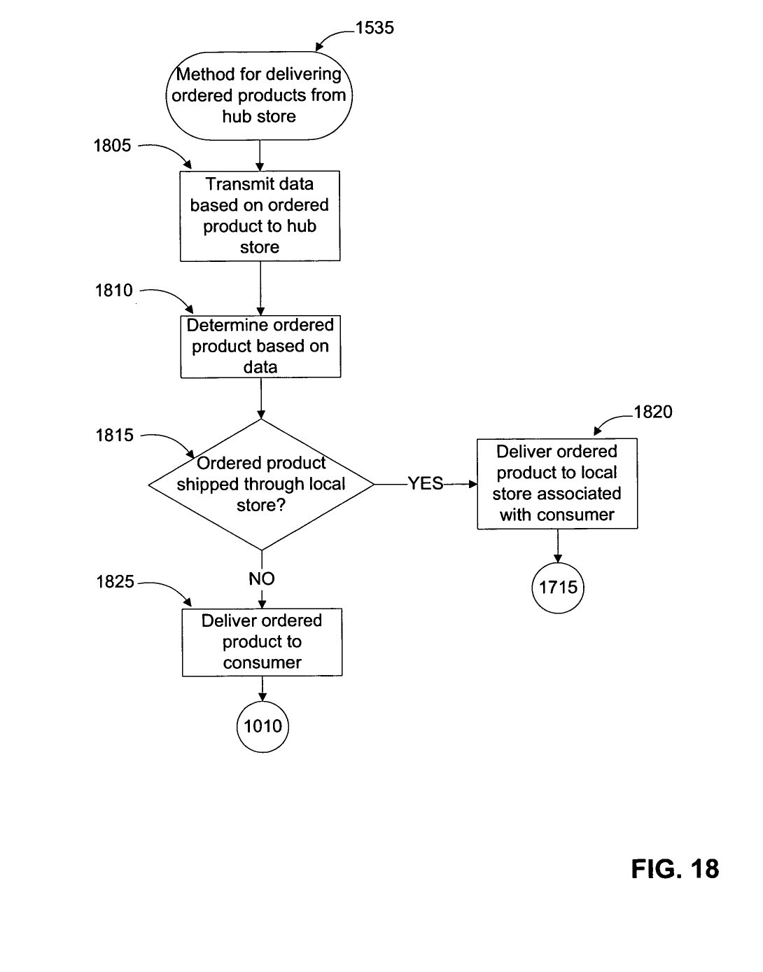

If the consumer's 302 local store 234 does not have the product 126, the method 1005 proceeds to step 1530. In step 1530, the method 1005 determines if the hub store 232 has the product 126. In exemplary embodiments, the server computer 108 can transmit data 120 corresponding with the product 126 to the hub store's 232 information processing unit 464. The information processing unit 464 then can determine whether the hub store 232 has the product 126. In exemplary embodiments, the determination can comprise determining whether the hub store 232 offers the product 126 for sale generally and determining whether the hub store 232 has the product 126 in stock. In certain embodiments, the hub store 232 can comprise non-perishable products 126 that can be delivered directly to the consumer 302 without the need for a refrigerated delivery vehicle 104. If the hub store 232 has the product 126, the method 1005 proceeds to step 1535, where the product 126 is delivered to the consumer 302 from the hub store 232. After step 1535, which will be discussed in more detail with reference to FIG. 18, the method 1005 returns to step 1510.

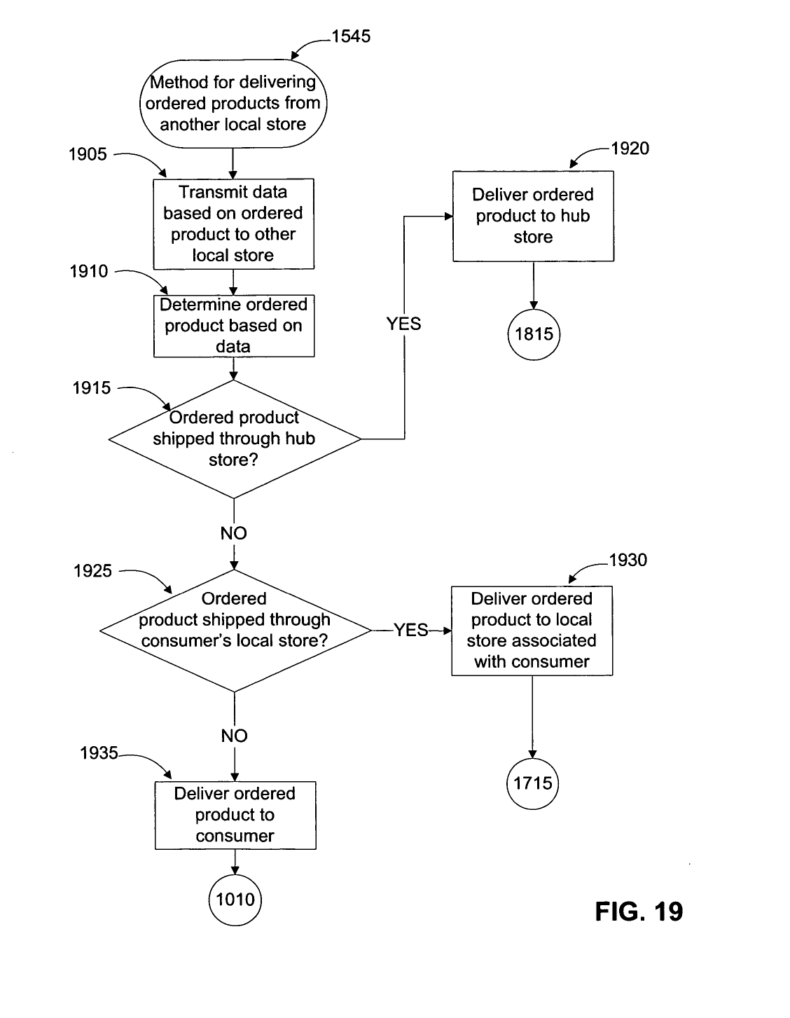

If the hub store 232 does not have the product 126, the method 1005 proceeds to step 1540. In step 1540, the method 1005 determines if another local store 234 has the product 126. In exemplary embodiments, the server computer 108 can transmit data 120 corresponding with the product 126 to the information processing unit 460 of one or more local stores 234 other than the consumer's 302 local store 234. The information processing unit 460 then can determine whether another local store 234 has the product 126. In exemplary embodiments, the determination can comprise determining whether the other store 234 offers the product 126 for sale generally and determining whether the other store 234 has the product 126 in stock. If another local store 234 has the product 126, the method 1005 proceeds to step 1545, where the product 126 is delivered to the consumer 302 from the other local store 234. After step 1545, which will be discussed in more detail with reference to FIG. 19, the method 1005 returns to step 1510.

In exemplary embodiments, consumers 302 can order products 126 that are not carried by their local store 234 or the hub store 232 but are carried by another local store 234 to provide consumers 302 in one geographic market access to products 126 generally found in another geographic market. For example, a consumer 302 in Nebraska can order specific brands of Florida orange juice generally sold in the southeast United States.

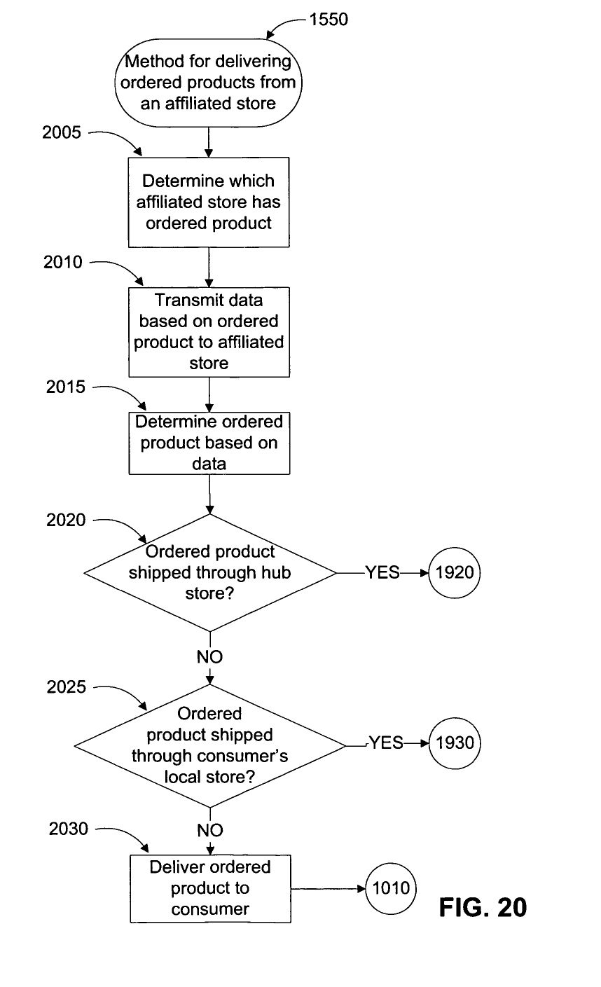

If another local store 234 does not have the product 126, the method 1005 proceeds to step 1550. In step 1550, which will be discussed in more detail with reference to FIG. 20, the product 126 is delivered to the consumer 302 from an affiliated store 106. In exemplary embodiments, an affiliated store 106 can comprise any store 106 outside of the set of related stores 200. In certain embodiments, these affiliated stores 106 can comprise other grocery stores such as specialty grocery stores or larger grocery stores, discount warehouse stores, office supply stores and/or department stores. In exemplary embodiments, a home grocery delivery provider can negotiate with affiliated stores 106 for the affiliated stores 106 to supply products 126 carried in the affiliated stores 106 to consumers 302 of the home grocery delivery provider. After step 1550, the method 1005 returns to step 1510.

FIG. 17 is a flow chart depicting a method 1525 for delivering ordered products 126 from a consumer's 302 local store 234 according to an exemplary embodiment, as referenced in step 1525 of FIG. 15. The method 1525 will be described with reference to FIGS. 1-7 and 17.

In step 1705, data 120 based on ordered products 126 is transmitted to the consumer's 302 local store 234. In certain embodiments, the data 120 can be order data 122, which can comprise any data 120 that identifies the product 126 ordered by the consumer 302. In particular embodiments, identifying the product 126 can include identifying the type of product 126, brand of the product 126, and the size and form of the product 126. In exemplary embodiments, the server computer 108 can transmit the order data 122 to the information processing unit 460 at the local store 234 via a network 116 such as the internet.

In step 1710, the ordered product 126 corresponding with the order data 122 is determined. In exemplary embodiments, determining the ordered product 126 based upon the order data 122 can be accomplished by transmitting order data 122 corresponding with the bar code that corresponds with the ordered product 126 and utilizing the information processing unit 460 to search a bar code guide 350 for the product 126 corresponding with the bar code.

In step 1715, the ordered product 126 is physically retrieved. In certain embodiments, the ordered product 126 can be retrieved from a storage space 452 within the local store 234. In other embodiments, the ordered product 126 can be retrieved from the main aisles of the local store 234. In other embodiments, the ordered product 126 can be retrieved from the “QwikShop” aisles of the local store 234. The distinction between main aisles and QwikShop aisles of a store 234 can relate to the types of products 126 located in the aisles, and will be discussed in more detail with reference to FIG. 23.

In step 1720, all retrieved ordered products 126 for the consumer 302 that are to be delivered from the local store 234 are aggregated. Although steps 1705, 1710, and 1715 of the method 1525 relate to delivering one ordered product 126, the method 1525 is performed for each product 126 in the consumer's 302 order that the consumer's 302 local store 234 has available, as shown by FIG. 15. Thus, in exemplary embodiments, step 1720 can comprise aggregating the ordered products 126 retrieved in each performance of step 1715.

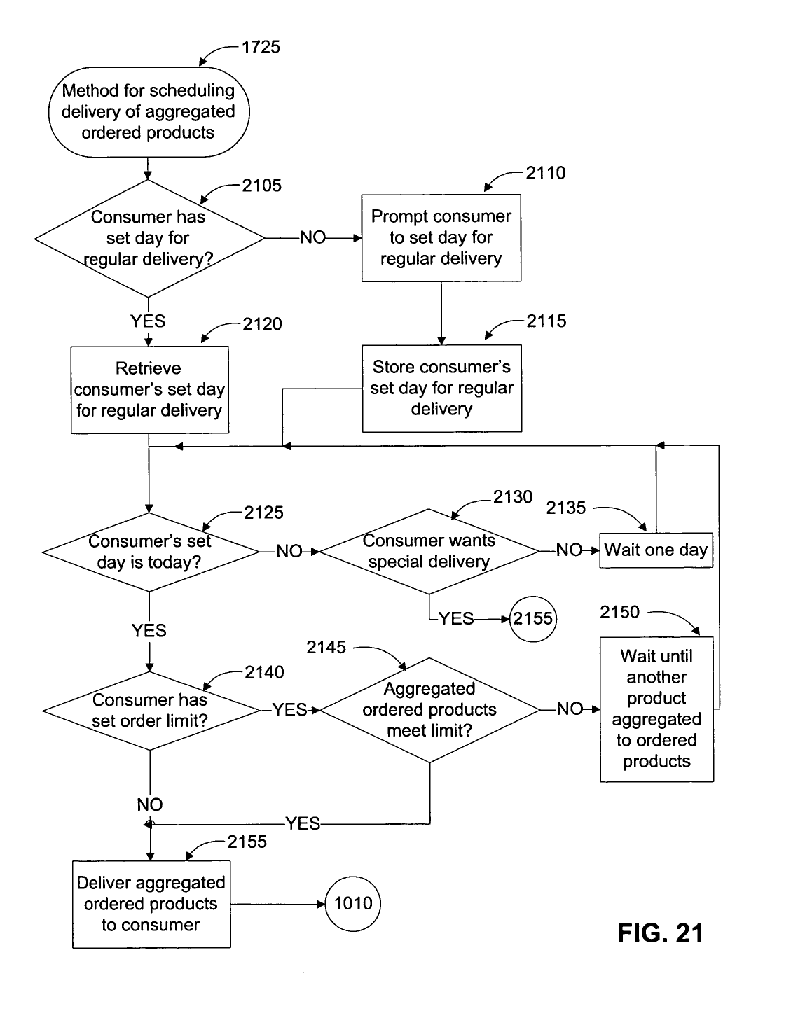

In step 1725, the delivery of the aggregated ordered products 126 is scheduled. In exemplary embodiments, scheduling the delivery of aggregated ordered products 126 can comprise determining the time to deliver the ordered products 126 to the consumer's 302 home 102, loading a delivery vehicle 104 with the products 126, and delivering the ordered products 126. Step 1725 will be discussed in more detail with reference to FIG. 21.

The method 1525 then proceeds to step 1010 shown in FIG. 10.

FIG. 21 is a flow chart depicting a method 1725 for scheduling a delivery of aggregated ordered products 126 according to an exemplary embodiment, as referenced in step 1725 of FIG. 17. The method 1725 will be described with reference to FIGS. 1-7 and 21.

In step 2105, the method 1725 determines if the consumer 302 has set a regular day for delivery. In exemplary embodiments, a consumer 302 can set one or more days for regular delivery, on which day the products 126 ordered by the consumer 302 since the last delivery can be delivered to the consumer's 302 home 102. In certain embodiments, a consumer 302 can set the delivery day when the consumer 302 registers for home grocery delivery. Consumer 302 registration is discussed in more detail with reference to FIG. 16. If the consumer 302 has not set a day for regular delivery, the method 1725 proceeds to step 2110.

In step 2110, the consumer 302 is prompted to set one or more days for regular delivery. In exemplary embodiments, the consumer 302 can be prompted to set one or more days for regular delivery and can respond to the prompt in any of the techniques described above in reference to step 1605 of FIG. 16. These techniques can include displaying a prompt on the consumer's 302 hand-held device 566 or prompting the consumer 302 via a webpage interface. The method 1725 then proceeds from step 2110 to step 2115 where the consumer's 302 set day for delivery is stored. In exemplary embodiments, the days can be stored in a data storage center 110 and associated with the consumer 302. The method 1725 then proceeds to step 2125.

If the method 1725 determined in step 2105 that the consumer 302 has set at least one day for regular delivery, then the one or more days are retrieved. In exemplary embodiments, the server computer 108 can retrieve the one or more days from a data storage center 110. The method 1725 then proceeds to step 2125.

In step 2125, the method 1725 determines if the current day is one of the consumer's 302 set days. If the current day is not one of the consumer's 302 set days, the method proceeds to step 2130.

In step 2130, the method 1725 determines if the consumer 302 wants a special delivery. In exemplary embodiments, a consumer 302 can request a special delivery if the consumer 302 wants the ordered products 126 to be delivered to the consumer's 302 home 102 on a day other than one of the consumer's 302 set days for regular delivery. In certain embodiments, the consumer 302 can be charged an extra fee for requesting a special delivery. If the consumer 302 wants the special delivery, the method 1725 proceeds to step 2155. If the consumer 302 does not want a special delivery, the method 1725 proceeds to step 2135, where the method 1725 waits one day and returns to step 2125.

If the method 1725 determined in step 2125 that the current day is one of the consumer's 302 set days, the method 1725 proceeds to step 2140. In step 2140, the method 1725 determines whether the consumer 302 has set an order limit. In exemplary embodiments, a consumer 302 who has set one or more days for regular deliver also can set an order limit, wherein ordered products 126 will be delivered to the consumer 302 on the next day for regular deliver unless the aggregated ordered products 126 do not meet the order limit. In certain embodiments, the order limit can comprise a price minimum or a product 126 piece minimum. If the consumer 302 has set an order limit, the method 1725 proceeds to step 2145. If the consumer 302 has not set an order limit, the method 1725 proceeds to step 2155.

In step 2145, the method 1725 determines if the aggregated ordered products 126 meet the limit set by the consumer 302. If the aggregated products 126 do not meet the limit, the method 1725 proceeds to step 2150, where the method 1725 waits until another product 126 is aggregated to the ordered products 126 and returns to step 2125. If the aggregated products 126 meet the limit set by the consumer 302, the method 1725 proceeds to step 2155.

In step 2155, the aggregated ordered products 126 are delivered to the consumer 302. In exemplary embodiments, the consumer 302 can be requested to confirm the delivery before the products 126 are actually delivered. In certain embodiments, the consumer 302 also can cancel the scheduled delivery.

In certain embodiments, delivering the aggregated ordered products 126 can comprise ensuring that the consumer 302 or another person will be at home 102 when the delivery vehicle 104 arrives at the consumer's 302 home 102.

In exemplary embodiments, the aggregated ordered products 126 can be deposited in a container such as a smart pantry 336. In certain embodiments, the smart pantry 336 can comprise a storage space 780 that can store products 126. In certain embodiments, the smart pantry 336 also can comprise a refrigerated storage space called a smart milk box 782 that can store perishable products 126. In exemplary embodiments, the smart milk box 782 can receive power 794 to refrigerate its contents from a connected power supply 788.

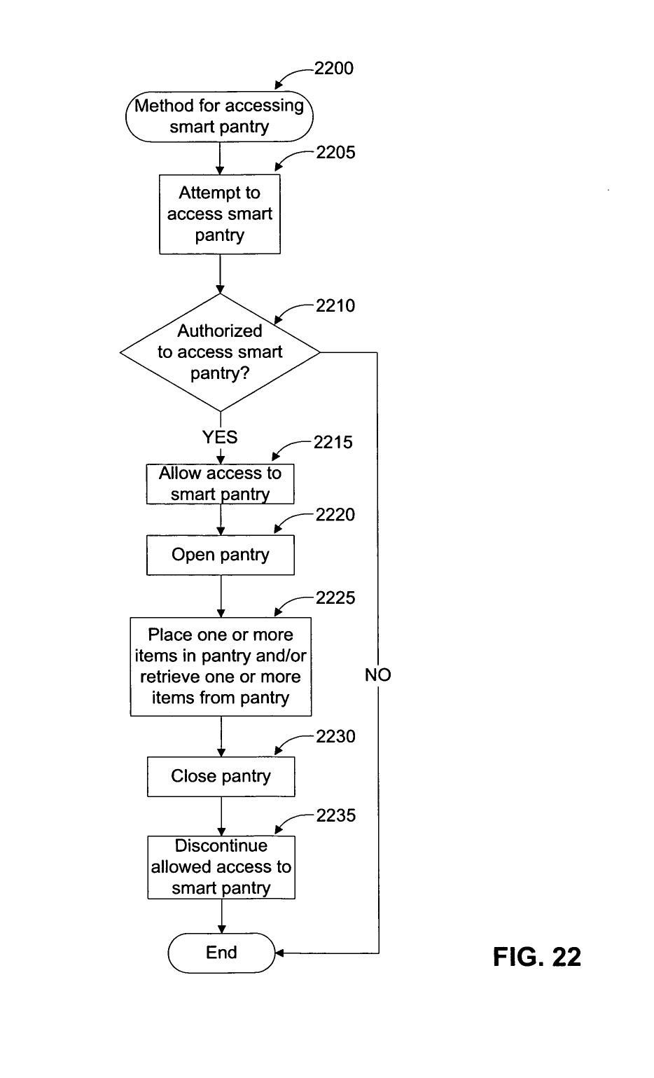

In certain embodiments, consumers 302 seeking to return products 126 that were delivered to their homes 102 can deposit the product 126 to return with the delivery vehicle 104 whenever the delivery vehicle 104 comes to the home 102. In exemplary embodiments, consumers 302 also can return a product 126 by depositing the product 126 in a smart pantry 336 or the smart milk box 782 within a smart pantry 336 and indicating that the delivery vehicle 104 should retrieve the product 126 during its next trip and return the product 126 to the store 106. Accessing the smart pantry 336 is described in more detail with reference to FIG. 22.

FIG. 18 is a flow chart depicting a method 1535 for delivering ordered products 126 from a hub store according to an exemplary embodiment, as referenced in step 1535 of FIG. 15. The method 1535 will be described with reference to FIGS. 1-7 and 18.

In step 1805, data 120 based on ordered products 126 is transmitted to a hub store 232. In certain embodiments, the data 120 can be order data 122, which can comprise any data 120 that identifies the product 126 ordered by the consumer 302. In particular embodiments, identifying the product 126 can include identifying the type of product 126, brand of the product 126, and the size and form of the product 126. In exemplary embodiments, the server computer 108 can transmit the order data 122 to the information processing unit 464 at the hub store 232 via a network 116 such as the internet.

In step 1810, the ordered product 126 corresponding with the order data 122 is determined. In exemplary embodiments, determining the ordered product 126 based upon the order data 122 can be accomplished by transmitting order data 122 corresponding with the bar code that corresponds with the ordered product 126 and utilizing the information processing unit 464 to search a bar code guide 350 for the product 126 corresponding with the bar code. In exemplary embodiments, the ordered product 126 then can be physically retrieved.

In step 1815, the method 1535 determines whether the ordered product 126 is to be shipped through the consumer's 302 local store 234. If the ordered product 126 is to be shipped through the consumer's 302 local store 234, the method 1535 proceeds to step 1820.

In step 1820, the ordered product 126 is delivered to the local store 234 associated with the consumer 302. The local store 234 associated with the consumer 302 was determined in step 1505 of FIG. 15. The ordered product 126 can be delivered from the hub store 232 to the consumer's 302 local store 234 via delivery vehicles 404A, 404B. In one embodiment, a delivery vehicle 404A can transport the ordered product 126 from the hub store 232 to an intermediate warehouse 462. The same 404A or another delivery vehicle 404B then can transport the products 126 from the intermediate warehouse 462 to the local store 234. The method 1535 then proceeds to step 1715 of FIG. 17.

If the ordered product 126 is not to be shipped through the consumer's 302 local store 234, the method 1535 proceeds to step 1825. In step 1825, the ordered product 126 is delivered directly to the consumer 302. In certain embodiments, the ordered product 126 can be delivered to the consumer's 302 home 102 via a delivery vehicle 104. In some embodiments, the delivery vehicle 104 can be affiliated with the home grocery delivery provider. In other embodiments, the delivery vehicle 104 can belong to an independent parcel delivery service. The method 1535 then proceeds to step 1010.

FIG. 19 is a flow chart depicting a method 1545 for delivering ordered products 126 from a local store 234 other than the consumer's 302 local store 234 according to an exemplary embodiment, as referenced in step 1545 of FIG. 15. The method 1545 will be described with reference to FIGS. 1-7 and 19.

In step 1905, data 120 based on ordered products 126 is transmitted to a local store 234 that has the ordered product 126. In exemplary embodiments, the server computer 108 can transmit the order data 122 to the information processing unit 460 at the local store 234 via a network 116 such as the internet.

In step 1910, the ordered product 126 corresponding with the order data 122 is determined. In exemplary embodiments, determining the ordered product 126 based upon the order data 122 can be accomplished by transmitting order data 122 corresponding with the bar code that corresponds with the ordered product 126 and utilizing the information processing unit 460 to search a bar code guide 350 for the product 126 corresponding with the bar code. In exemplary embodiments, the ordered product 126 then can be physically retrieved.

In step 1915, the method 1545 determines whether the ordered product 126 is to be shipped through the hub store 232. If the ordered product 126 is to be shipped through the hub store 232, the method 1545 proceeds to step 1920. If the ordered product 126 is not to be shipped through the hub store 232, the method 1545 proceeds to step 1925.

In step 1920, the ordered product 126 is delivered to the hub store 232. In exemplary embodiments, the ordered product 126 can be delivered from this local store 234 to the hub store 232 via delivery vehicles 404A, 404B. In certain embodiments, one delivery vehicle 404B can transport the ordered product 126 from this local store 234 to an intermediate warehouse 462, and another 404A or the same delivery vehicle 404B can transport the ordered product 126 to the hub store 232.

In step 1925, the method 1545 determines whether the ordered product 126 is to be shipped through the consumer's 302 local store 234. If the ordered product 126 is to be shipped through the consumer's 302 local store 234, the method 1545 proceeds to step 1930.

In step 1930, the ordered product 126 is delivered to the local store 234 associated with the consumer 302. The local store 234 associated with the consumer 302 was determined in step 1505 of FIG. 15. The ordered product 126 can be delivered from this local store 234 to the consumer's 302 local store 234 via delivery vehicles 404A, 404B. The method 1545 then proceeds to step 1715 of FIG. 17.

If the ordered product 126 is not to be shipped through the consumer's 302 local store 234, the method 1545 proceeds to step 1935. In step 1935, the ordered product 126 is delivered directly to the consumer 302. In certain embodiments, the ordered product 126 can be delivered to the consumer's 302 home 102 via a delivery vehicle 104. In some embodiments, the delivery vehicle 104 can be affiliated with the home grocery delivery provider. In other embodiments, the delivery vehicle 104 can belong to an independent parcel delivery service. The method 1545 then proceeds to step 1010.

FIG. 20 is a flow chart depicting a method 1550 for delivering ordered products 126 from an affiliated store 106 according to an exemplary embodiment, as referenced in step 1550 of FIG. 15. The method 1550 will be described with reference to FIGS. 1-7 and 20.

In step 2005, the affiliated store 106 that has the ordered product 126 is determined. In exemplary embodiments, affiliated stores 106 can comprise information processing units 460 that track the products 126 carried by the store 106. The server computer 108 can retrieve the inventory of these affiliated stores' 106 information processing units 460 via a network 116 such as the internet.

In certain embodiments, more than one affiliated store 106 can have the ordered product 126. In these embodiments, one of these affiliated stores 106 can be chosen. The chosen affiliated store 106 can be determined based upon factors such as proximity to the consumer's 302 home 102 or the lowest cost in transporting the product 126 to the consumer's 302 home 102.

In step 2010, data 120 based on ordered products 126 is transmitted to the affiliated store 106. In exemplary embodiments, the server computer 108 can transmit the order data 122 to the information processing unit 460 at the affiliated store 106 via a network 116 such as the internet.

In step 2015, the ordered product 126 corresponding with the order data 122 is determined. In exemplary embodiments, determining the ordered product 126 based upon the order data 122 can be accomplished by transmitting order data 122 corresponding with the bar code that corresponds with the ordered product 126 and utilizing the information processing unit 460 to search a bar code guide 350 for the product 126 corresponding with the bar code.

In step 2020, the method 1550 determines whether the ordered product 126 is to be shipped through the hub store 232. If the ordered product 126 is to be shipped through the hub store 232, the method 1550 proceeds to step 1920 of FIG. 19. If the ordered product 126 is not to be shipped through the hub store 232, the method 1550 proceeds to step 2025.

In step 2025, the method 1550 determines whether the ordered product 126 is to be shipped through the consumer's 302 local store 234. If the ordered product 126 is to be shipped through the consumer's 302 local store 234, the method 1550 proceeds to step 1930 of FIG. 19.

If the ordered product 126 is not to be shipped through the consumer's 302 local store 234, the method 1550 proceeds to step 2030. In step 2030, the ordered product 126 is delivered directly to the consumer 302. In certain embodiments, the ordered product 126 can be delivered to the consumer's 302 home 102 via a delivery vehicle 104. In some embodiments, the delivery vehicle 104 can be affiliated with the home grocery delivery provider. In other embodiments, the delivery vehicle 104 can belong to an independent parcel delivery service. The method 1550 then proceeds to step 1010.

FIG. 22 is a flow chart depicting a method 2200 for accessing a smart pantry 336 according to an exemplary embodiment. The method 1725 will be described with reference to FIGS. 1-7 and 22.

In step 2205, a person attempts to access the smart pantry 336. In exemplary embodiments, people who may attempt to access a smart pantry 336 can be the owner of the smart pantry 336, an acquaintance of the owner, a person attempting to deliver items to the owner, or a person attempting to retrieve items from the owner. In certain embodiments, the smart pantry 336 can comprise an open slot 784 that can receive envelopes or small packages from people who do not necessarily need access to the smart pantry 336.

In step 2210, the method 2200 determines if the person attempting to access the smart pantry 336 has access to the smart pantry 336. In exemplary embodiments, the owner of the smart pantry 336 can determine which people can have access to the smart pantry 336. In certain embodiments, the owner can determine specific people, such as particular friends or relatives. The owner also can grant access to people by virtue of their association with an entity. For example, the owner can grant access to all delivery employees of a home grocery delivery provider.

In exemplary embodiments, the owner also can allow certain people and/or entities to grant access to the smart pantry 336 to other people. For example, the owner can allow a home grocery delivery provider, a condominium or home owners association, or a third party access control service to grant access to other people. In particular embodiments, these certain people and/or entities can grant access to other people by inputting an identification number or code associated with a person to be granted access, and then transmitting the identification number or code to a smart server 790, which can communicate with a processor 786 in the smart pantry 336.

The owner can grant access to authorized people by utilizing different techniques. In certain embodiments, the owner can provide a physical key to the smart pantry 336 to authorized people. In other embodiments, the owner can provide an electronic key to authorized people. Electronic keys can comprise any electronic device that can provide secured access to the smart pantry 336 to authorized people. In exemplary embodiments, a smart pantry 336 can comprise a biometric reader that can provide secured access to authorized people based upon a biometric reading of a person attempting to gain access. Biometric readers can include retinal scanning devices and fingerprint scanning devices.

In exemplary embodiments, smart boxes allowing secured access by utilizing electronic keys or biometric readers can comprise a processor 786 connected to a power supply 788 to receive the electronic key or biometric signal and to transmit the signal to a smart server 790 via a network 792 such as the internet. In certain embodiments, the owner of the smart pantry 336 can transmit to the smart server 790 the people authorized for access to the smart pantry 336, and the smart server 790 then can determine whether people attempting to access the smart pantry 336 should be allowed access.

If the method 2200 determines that the person attempting to access the smart pantry 336 is not authorized, the method 2200 ends. If the person attempting the access the smart pantry 336 is authorized, the method 2200 proceeds to step 2215.

In step 2215, access to the smart pantry 336 is allowed. In certain embodiments, access can be allowed by unlocking or opening a point of access to the smart pantry 336 other than the slot 784.

In step 2220, the smart pantry 336 is opened. In certain embodiments, opening the smart pantry 336 can provide access to the storage space 780 and/or smart milk box 782 components.

In step 2225, one or more items are placed in and/or retrieved from the smart pantry 336. In exemplary embodiments, when items are to be retrieved from the smart pantry 336, an optional signal such as a raised flag can be present on the smart pantry 336, to notify the presence of items to be picked up. In exemplary embodiments, such items can include grocery products 126 delivered to the owner's home 102 but that are to be returned to the store 106. In other exemplary embodiments, such items can include laundry being picked up for dry cleaning or laundry services.

In step 2230, the smart pantry 336 is closed.

In step 2235, access to the smart pantry 336 is discontinued. In exemplary embodiments, discontinuing access can include preventing reopening the smart pantry 336 without re-authorizing access to the smart pantry 336.

In certain embodiments, the smart pantry 336 can store the identity of the person accessing the pantry 336, as well as the time and date of the person's access. The smart pantry 336 can determine this time, date, and identity information with the processor 786 and then transmit such information to the smart server 790 via a network 792. In certain embodiments, the smart server 790 can transmit the time, date, and identity information to a data storage center, where such information can be stored each time the smart pantry 336 is accessed. In exemplary embodiments, the owner of the smart pantry 336 can view historical time, date, and identity information associated with the smart pantry 336. In particular embodiments, the owner can view the historical information via a website interface.

After step 2235, the method 2200 ends.

FIG. 23 is a flow chart depicting a method 2300 for stocking a store 106 according to an exemplary embodiment. The method 2300 will be described with reference to FIGS. 1-7 and 23.

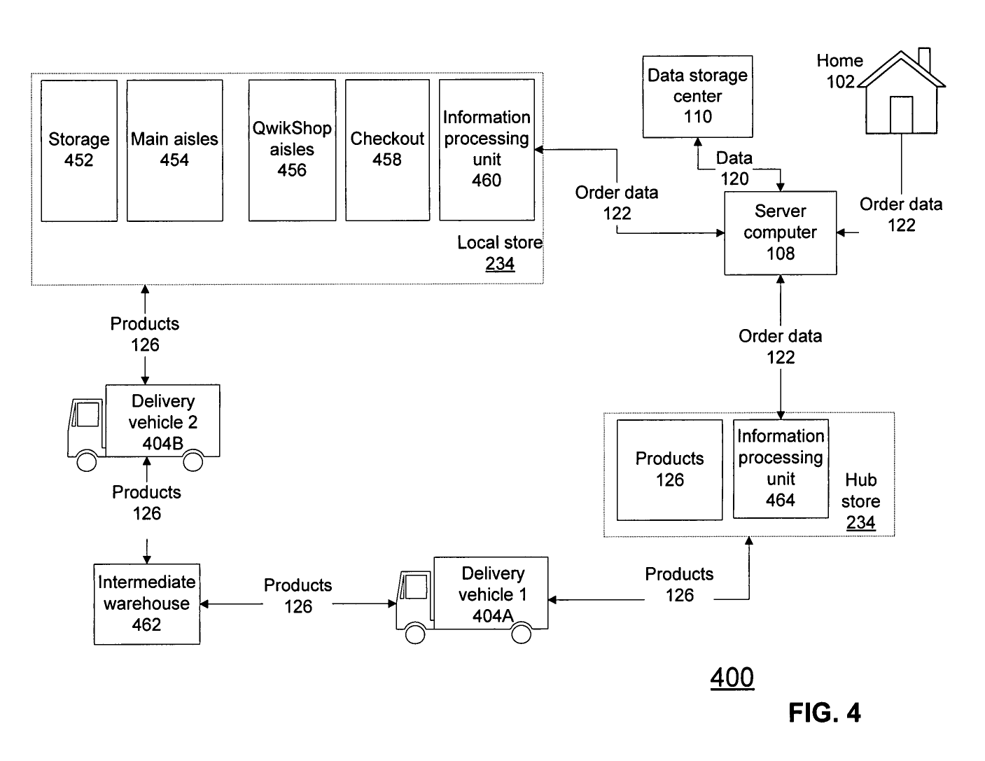

In step 2305, inventory of multiple types of products 126 is provided to a store 106. In exemplary embodiments, the store 106 can be a grocery store. In certain embodiments, the store 106 can be a local store 234 that provides home grocery ordering and delivery as shown in FIG. 4. In exemplary embodiments, the inventory can be stored in a storage area 452 within the store 234.

In step 2310, at least one of each type of the multiple types of products 126 is placed in the main aisles 454 of the store 234. In certain embodiments, some types of the products need not have items placed in the main aisles 454 of the store 234. In these embodiments, the entire stock of such types of items can remain in the storage area 452 of the store 234.

In step 2315, a subset of types of products 126 is selected from the multiple types of products 126, wherein the subset comprises products 126 that are available for home order and delivery. Products 126 sold in a grocery store can be divided into five categories: (1) Non-perishable commodities such as detergent, paper towels, cereal, canned soup, diapers, coffee, canned tuna, salad dressings, oils, and sugar; (2) Durable perishable commodities such as milk, orange juice, butter, bread, fruits, and vegetables; (3) Non-perishable or low frequency repeat transaction Epicurean items, such as specialty crackers, canned anchovies, pickles, dietary items, spices, and cake mixes; (4) Perishable Epicurean, “fragile,” or “spoil-sensitive” items such as grapes, kiwi fruit, butcher items, humus, cold cuts, and frozen foods; and (5) Usually low volume specialty items such as light bulbs, batteries, lighter fluid, matches, health and beauty aid items, and home office supplies.

In exemplary embodiments, the subset of types of products 126 can comprise items from category 1 and/or category 2 because those types of items can be more desirable for home delivery and quick, convenient shopping.

In step 2320, at least one item of each type within the subset of types of products 126 is placed in a second portion of the store 234. In exemplary embodiments, the second portion of the store 234 can comprise QwikShop aisles 456. The QwikShop aisles 456 can comprise products 126 that are chosen because of the high demand, frequency of use, and/or frequency of purchase generally associated with the products 126. In certain embodiments, products 126 found in the QwikShop aisles 456 also can be found in the main aisles 454 of the store 234.

After step 2320, the method 2300 ends.

In an exemplary embodiment, the present invention can comprise one or more of the technologies, methods, or systems disclosed in U.S. patent application Ser. No. 10/976,149, filed Oct. 28, 2004, entitled “Method and System for Interacting with a Writing,” and published as U.S. Patent Application Publication No. 2005/0060232. That is, a system or method based on the preceding disclosure can comprise any of the disclosure or teachings in U.S. Patent application Publication No. 2005/0060232, which is incorporated in the disclosure of this patent application.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit. Accordingly, such alternative embodiments are implicitly included in the invention described herein.

The invention can be used with computer hardware and software that performs some of the methods and processing functions described above. As will be appreciated by those skilled in the art, some of the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope defined in the following claims, the scope of which is to be accorded the broadest interpretation so as to encompass such modifications and equivalent structures.

What is claimed is:

1. A method for generating a product order and delivering the ordered product to a consumer, comprising the steps of:
receiving data communicated from the consumer's home and generated from a bar code associated with a product;
identifying the product associated with the data generated from the bar code;
communicating the identified product to an entity capable of delivering the product; and
delivering the identified product by the entity to the consumer's home.

2. A method for stocking products available for home delivery in a store, comprising the steps of:
identifying a limited number of home-delivery products that are available for a consumer to order from their home and that the store will deliver to the consumer's home;
stocking a portion of the store with the limited number of home-delivery products; and
stocking another portion of the store with non-home-delivery products and the home-delivery products.
